SEQUENCE LISTING (1 sequence)

SEQ ID NO: 1 - protein, 275 aa, Bacillus subtilis
AQSVPYGVSQIKAPALHSQGYTGSNVKVAVIDSGIDSSHPDLKVAGGASMVPSETNPFQDNNSHGTHVAGTVAALNNSIGVLGVAPSASLYAVKVLGADGSGQYSWIINGIEWAIANNMDVINMSLGGPSGSAALKAAVDKAVASGVVVVAAAGNEGTSGSSSTVGYPGKYPSVIAVGAVDSSNQRASFSSVGPELDVMAPGVSIQSTLPGNKYGALNGTSMASPHVAGAAALILSKHPNWTNTQVRSSLENTTTKLGDSFYYGKGLINVQAAAQ

(19) United States
(12) Patent Application Publication
(10) Pub. No.: US 2024/0008511 A1
(43) Pub. Date: Jan. 11, 2024

(54) FEED COMPOSITIONS FOR ANIMAL HEALTH

(71) Applicants: DUPONT NUTRITION BIOSCIENCES, Copenhagen K (DK); GENECOR INTERNATIONAL BV, BG Oegstgeest (NL)

(72) Inventors: Susan Arent LUND, Brabrand (DK); Leon MARCHAL, Leiden (NL)

(21) Appl. No.: 18/030,441

(22) PCT Filed: Oct. 15, 2021
(86) PCT No.: PCT/US2021/055137

§ 371 Date: Apr. 5, 2023

Related U.S. Application Data
(60) Provisional application No. 63/092,847, filed on Oct. 16, 2020.

(51) Int. Cl. A23K 20/189; A23K 20/158; A23K 50/75

(52) U.S. Cl. CPC A23K 20/189; A23K 20/158; A23K 50/75

(57) ABSTRACT

Provided herein, inter alia, are diets, feeds, and feed additive compositions comprising bio-efficient proteases useful for improving animal health and/or performance, as well as methods of making and using the same

### CROSS-REFERENCE TO RELATED APPLICATIONS

This application claims priority to U.S. Provisional Patent Application No. 63/092,847, filed Oct. 16, 2020, the disclosure of which is incorporated by reference herein in its entirety.

### FIELD OF THE INVENTION

Provided herein, inter alia, are diets, feeds, and feed additive compositions comprising proteases useful for improving animal health and/or performance, as well as methods of making and using the same.

### BACKGROUND

Proteins are essential nutritional factors for animals and humans. Most livestock and many human beings get necessary dietary proteins from vegetable protein sources. Important vegetable protein sources are, for example, oilseed crops, legumes and cereals. However, these sources can be inefficient, since significant quantities of protein-containing solids are often not digested when a vegetable protein source, such as soybean meal, is included in the feed of monogastric animals, such as swine and poultry.

The use of proteases in animal feed has become more widespread over the past several years, subsequent to the acceptance of other common feed additive enzymes like xylanases, amylases, and phytases. Protease supplementation of animal feed can help to reduce costs associated with animal feed by decreasing the amount of crude protein required for animals to achieve desired weight gain. However, the effects of exogenous proteases on animal performance do not necessarily reflect the in vitro digestibility of protein from ingredients but can also be influenced by a variety of factors that affect their overall bio-efficacy (Romero, & Plumstead, 2013. Proc. 24th Aus. Poult. Sci. Symp. Sydney, New South Wales, Australia). For example, serine proteases in broiler chickens do not appear to show a linear dose response on protein digestibility of complete feeds, but an optimum is present (Arguelles-Ramos et al., 2010. SPSS Meeting Abstracts, 12), after which marginal reductions with increasing protease doses are evident. This suggests that a balance between the hydrolysis of dietary protein and undefined physiological interactions in the intestine may limit further improvements in protein retention due to protease activity (Romero, & Plumstead, 2013).

What is needed, therefore, are dietary conditions and/or feeds that increase protease bio-efficacy to help guide the formulation of diets that maximize protein utilization following administration to monogastric animals.

The subject matter disclosed herein addresses these needs and provides additional benefits as well.

### SUMMARY

Provided herein, inter alia, are protease-containing compositions that include diets, feeds, and feed additive compositions which have been formulated to increase protease bio-efficacy as well as methods for making and using the same.

Accordingly, in some aspects, provided herein is a method for improving the bio-efficacy of a protease-containing feed or diet, comprising adding a protease-containing feed additive composition to an animal feed characterized by one or more of: (a) a soybean meal having an acid detergent fiber (ADF) content greater than about 56 g/kg; (b) a soybean meal having a sulfur-containing amino acid content of less than about 13 g/kg; (c) a majority of particles comprising less than 1 mm in size; and/or (d) low buffer capacity. In some embodiments, the protease is a subtilisin, a bacillolysin, an alkaline serine protease, a keratinase or a Nocardiopsis protease. In some embodiments, the protease is 80% identical to the protease of SEQ ID NO:1. In some embodiments of any of the embodiments disclosed herein, the ADF content of the soybean meal is greater than about 58 g/kg, 60 g/kg, 62 g/kg, 64 g/kg, or 66 g/kg. In some embodiments of any of the embodiments disclosed herein, the sulfur-containing amino acid content of the soybean meal is less than about 12 g/kg or 11 g/kg. In some embodiments of any of the embodiments disclosed herein, at least about 60% of the particles in the animal feed comprise less than 1 mm in size. In some embodiments of any of the embodiments disclosed herein, the stabilized pH after addition of 0.3 mol/kg HCl to a 10% suspension of the animal feed is less than 4.2. In some embodiments of any of the embodiments disclosed herein, less than 0.44 mol/kg HCl is added to a 10% suspension of the animal feed to reach a pH-value of 4.0. In some embodiments of any of the embodiments disclosed herein, the feed additive composition further comprises one or more additional enzymes selected from the group consisting of a xylanase, amylase, phytase, glucoamylase, pectinase, mannanase, and β-glucanase. In some embodiments of any of the embodiments disclosed herein, the feed additive composition further comprises one or more direct fed microbials (DFMs) or fermentates thereof. In some embodiments, the DFM comprises a bacterium from one or more of the following genera: Lactobacillus, Lactococcus, Streptococcus, Bacillus, Pediococcus, Enterococcus, Leuconostoc, Carnobacterium, Propionibacterium, Bifidobacterium, Clostridium or Megasphaera and combinations thereof. In some embodiments of any of the embodiments disclosed herein, the DFM comprises a bacterium from one or more of the following species: Bacillus subtilis, Bacillus licheniformis, Bacillus amyloliquefaciens, Enterococcus sp, Pediococcus sp, Lactobacillus sp, Bifidobacterium sp, Lactobacillus acidophilus, Pediococsus acidilactici, Lactococcus lactis, Bifidobacterium bifidum, Propionibacterium thoenii, Lactobacillus farciminus, Lactobacillus rhamnosus, Clostridium butyricum, Bifidobacterium animalis ssp. animalis, Lactobacillus reuteri, Bacillus cereus, Lactobacillus salivariu, Megasphaera elsdenii, Propionibacteria sp, or combinations thereof. In some embodiments of any of the embodiments disclosed herein, the feed additive composition further comprises one or more essential oils. In some embodiments, the essential oil is thymol and/or cinnamaldehyde.

In other aspects, provided herein is a method for formulating a diet for an animal, the method comprising combining a protease with one or more of: (a) a soybean meal having an acid detergent fiber (ADF) content greater than about 56 g/kg; and/or (b) a soybean meal having a sulfur-containing amino acid content of less than about 13 g/kg; wherein, optionally, (c) a majority of particles in the diet comprise less than 1 mm in size; and/or (d) the diet has low buffer capacity. In some embodiments, the protease is a subtilisin, a bacillolysin, an alkaline serine protease, a keratinase or a Nocardiopsis protease. In some embodiments, the protease is 80% identical to the protease of SEQ ID NO:1. In some embodiments of any of the embodiments disclosed herein, the ADF content of the soybean meal is greater than about 58 g/kg, 60 g/kg, 62 g/kg, 64 g/kg, or 66 g/k. In some embodiments of any of the embodiments disclosed herein, the sulfur-containing amino acid content of the soybean meal is less than about 12 g/kg or 11 g/kg. In some embodiments of any of the embodiments disclosed herein, at least about 60% of the particles in the diet comprise less than 1 mm in size. In some embodiments of any of the embodiments disclosed herein, the stabilized pH after addition of 0.3 mol/kg HCl to a 10% suspension of the animal feed is less than 4.2. In some embodiments of any of the embodiments disclosed herein, less than 0.44 mol/kg HCl is added to a 10% suspension of the animal feed to reach a pH-value of 4.0. In some embodiments of any of the embodiments disclosed herein, the diet further comprises one or more additional enzymes selected from the group consisting of a xylanase, amylase, phytase, glucoamylase, pectinase, mannanase, and β-glucanase. In some embodiments of any of the embodiments disclosed herein, the diet further comprises one or more direct fed microbials (DFMs) or fermentates thereof. In some embodiments, the DFM comprises a bacterium from one or more of the following genera: Lactobacillus, Lactococcus, Streptococcus, Bacillus, Pediococcus, Enterococcus, Leuconostoc, Carnobacterium, Propionibacterium, Bifidobacterium, Clostridium or Megasphaera and combinations thereof. In some embodiments of any of the embodiments disclosed herein, the DFM comprises a bacterium from one or more of the following species: Bacillus subtilis, Bacillus licheniformis, Bacillus amyloliquefaciens, Enterococcus sp, Pediococcus sp, Lactobacillus sp, Bifidobacterium sp, Lactobacillus acidophilus, Pediococsus acidilactici, Lactococcus lactis, Bifidobacterium bifidum, Propionibacterium thoenii, Lactobacillus farciminus, Lactobacillus rhamnosus, Clostridium butyricum, Bifidobacterium animalis ssp. animalis, Lactobacillus reuteri, Bacillus cereus, Lactobacillus salivariu, Megasphaera elsdenii, Propionibacteria sp, or combinations thereof. In some embodiments of any of the embodiments disclosed herein, the diet further comprises one or more essential oils. In some embodiments, the essential oil is thymol and/or cinnamaldehyde. In some embodiments of any of the embodiments disclosed herein, the animal is a monogastric animal. In some embodiments, the animal is poultry (for example, broilers, layer, broiler breeders, turkey, duck, geese, pheasant, columbidae or water fowl), swine, rabbits, cows (including calves), goats (including kids), sheep (including lambs), horses, insects, a companion animal (for example dogs, cats) or fish.

In further aspects, provided herein is a diet formulated by any of the methods disclosed herein.

In yet other aspects, provided herein is a diet comprising: (a) a feed additive composition comprising a protease; and one or more of (b) a soybean meal having an acid detergent fiber (ADF) content greater than about 56 g/kg; and/or (b) a soybean meal having a sulfur-containing amino acid content of less than about 13 g/kg; wherein, optionally, (c) a majority of particles in the diet comprise less than 1 mm in size; and/or (d) the diet has low buffer capacity. In some embodiments, the protease is a subtilisin, a bacillolysin, an alkaline serine protease, a keratinase or a Nocardiopsis protease. In some embodiments, the protease is 80% identical to the protease of SEQ ID NO:1. In some embodiments of any of the embodiments disclosed herein, the ADF content of the soybean meal is greater than about 58 g/kg, 60 g/kg, 62 g/kg, 64 g/kg, or 66 g/kg. In some embodiments of any of the embodiments disclosed herein, the sulfur-containing amino acid content of the soybean meal is less than about 12 g/kg or 11 g/kg. In some embodiments of any of the embodiments disclosed herein, at least about 60% of the particles in the diet comprise less than 1 mm in size. In some embodiments of any of the embodiments disclosed herein, the stabilized pH after addition of 0.3 mol/kg HCl to a 10% suspension of the animal feed is less than 4.2. In some embodiments of any of the embodiments disclosed herein, less than 0.44 mol/kg HCl is added to a 10% suspension of the animal feed to reach a pH-value of 4.0. In some embodiments of any of the embodiments disclosed herein, the feed additive composition further comprises one or more additional enzymes selected from the group consisting of a xylanase, amylase, phytase, glucoamylase, pectinase, mannanase, and β-glucanase. In some embodiments of any of the embodiments disclosed herein, the feed additive composition further comprises one or more direct fed microbials (DFMs) or fermentates thereof. In some embodiments, the DFM comprises a bacterium from one or more of the following genera: Lactobacillus, Lactococcus, Streptococcus, Bacillus, Pediococcus, Enterococcus, Leuconostoc, Carnobacterium, Propionibacterium, Bifidobacterium, Clostridium or Megasphaera and combinations thereof. In some embodiments of any of the embodiments disclosed herein, the DFM comprises a bacterium from one or more of the following species: Bacillus subtilis, Bacillus licheniformis, Bacillus amyloliquefaciens, Enterococcus sp, Pediococcus sp, Lactobacillus sp, Bifidobacterium sp, Lactobacillus acidophilus, Pediococsus acidilactici, Lactococcus lactis, Bifidobacterium bifidum, Propionibacterium thoenii, Lactobacillus farciminus, Lactobacillus rhamnosus, Clostridium butyricum, Bifidobacterium animalis ssp. animalis, Lactobacillus reuteri, Bacillus cereus, Lactobacillus salivariu, Megasphaera elsdenii, Propionibacteria sp, or combinations thereof. In some embodiments of any of the embodiments disclosed herein, the feed additive composition further comprises one or more essential oils. In some embodiments, the essential oil is thymol and/or cinnamaldehyde.

In other aspects, provided herein is a method for improving feed conversion ratio (FCR) or for increasing body weight gain in an animal comprising administering any of the diets disclosed herein to the animal. In some embodiments, the animal is a monogastric animal. In some embodiments, the animal is poultry (for example, broilers, layer, broiler breeders, turkey, duck, geese, pheasant, columbidae or water fowl), swine, rabbits, calves, cows, goat, sheep, insects, a companion animal (for example dogs, cats) or fish.

Each of the aspects and embodiments described herein are capable of being used together, unless excluded either explicitly or clearly from the context of the embodiment or aspect.

Throughout this specification, various patents, patent applications and other types of publications (e.g., journal articles, electronic database entries, etc.) are referenced. The disclosure of all patents, patent applications, and other publications cited herein are hereby incorporated by reference in their entirety for all purposes.

### DETAILED DESCRIPTION

Use of proteases in the diets of animals such as poultry and swine has seen greater acceptance in large-scale livestock production in recent years, as producers seek to extract the greatest amount of nutrients from feed while at the same time keeping costs to a minimum. However, as is the case with all exogenously added dietary enzymes, the bio-efficacy of a given protease's ability to extract nutrients from a given feed can vary due to any number of factors related to the accompanying feed, feed additives, as well as the digestive tract of the animal at issue. As described in more detail herein, the inventors of the present application have surprisingly discovered that the bio-efficacy of protease-containing feed additives, feeds, and diets can be improved through dietary formulation recommendations that include one or more of the following: using a soybean meal with higher ADF values; using a soybean meal with a limited content of sulfur-containing amino acids; ensuring that most of the feed or feed stuff has a small particle size, and formulating the diet with a low buffer capacity. Diets formulated in accordance with one or more of these factors resulted in improved weight gain and feed conversion ratio for animals fed these diets in comparison to control animals that were not fed diets formulated in this manner.

### I. Definitions

As used herein, the phrase “improved bio-efficacy” or “improving the bio-efficacy” with respect to a protease, means that a feed or diet containing a protease or a protease-containing feed additive composition added to a feed or diet formulated in accordance with the methods disclosed herein results in a higher likelihood or greater consistency with respect to the ability of the protease to improve animal performance in one or more parameters. In some non-limiting embodiments, a protease added to a diet formulated in accordance with the methods disclosed herein results in an improvement in body weight gain by >3% compared to a control diet or an improvement in feed conversion ratio by >3% compared to a control diet.

As used herein, a feed or feed component's “acid detergent fiber (ADF) content” refers to the percentage of plant material in the feed's that is difficult or unable to be digested by an animal (such as a mon-gastric animal). The difficult or indigestible part typically contains cellulose, lignin, and silica. Feeds with higher ADF are lower in digestible energy than feeds with lower ADF. During laboratory analysis, ADF is the residue remaining after boiling a feed sample in acid detergent solution. ADF is often used to calculate digestibility, total digestible nutrients (TDN) and/or net energy for lactation (NEL).

“Sulfur-containing amino acid content” of a feed or feed component refers to the quantitative amount of cystine, cysteine and methionine in the feed or feed component.

The term “buffering capacity” as used herein refers to the ability of feed and/or feed additive materials in a formulated diet to resist pH change. Typically, buffering capacity is expressed in terms of the amount of strong acid or base required to change the pH of a composition in a given amount.

The terms “animal” and “subject” are used interchangeably herein and refer to any organism belonging to the kingdom Animalia and includes, without limitation, mammals (excluding humans), non-human animals, domestic animals, livestock, farm animals, zoo animals, breeding stock and the like. For example, there can be mentioned all non-ruminant and ruminant animals. In an embodiment, the animal is a non-ruminant, i.e., mono-gastric animal. Examples of mono-gastric animals include, but are not limited to, pigs and swine, such as piglets, growing pigs, sows; poultry such as turkeys, ducks, chicken, broiler chicks, layers; fish such as salmon, trout, tilapia, catfish and carps; and crustaceans such as shrimps and prawns. In a further embodiment, the animal is a ruminant animal including, but not limited to, cattle, young calves, goats, sheep, giraffes, bison, moose, elk, yaks, water buffalo, deer, camels, alpacas, llamas, antelope, pronghorn and nilgai.

The term “animal performance” as used herein may be determined by the feed efficiency and/or weight gain of the animal and/or by the feed conversion ratio and/or by the digestibility of a nutrient in a feed (e.g., amino acid digestibility or phosphorus digestibility) and/or digestible energy or metabolizable energy in a feed and/or by nitrogen retention and/or by animals' ability to avoid the negative effects of diseases or by the immune response of the subject.

By “improved animal performance” it is meant that there is increased feed efficiency, and/or increased weight gain and/or reduced feed conversion ratio and/or improved digestibility of nutrients or energy in a feed resulting from the use of feed comprising the protease-containing feed additive composition, feed, or diet described herein as compared to a feed which does not comprise said protease-containing feed additive composition, feed, or diet. In some embodiments, by “improved animal performance” it is meant that there is increased feed efficiency and/or increased weight gain and/or reduced feed conversion ratio. As used herein, the term “feed efficiency” refers to the amount of weight gain in an animal that occurs when the animal is fed ad-libitum or a specified amount of food during a period of time. The improvement in performance parameters may be in respect to a control in which the protease-containing feed used does not comprise a one or more of the diets or dietary parameters disclosed herein. In some embodiments, an improvement in animal performance is due to the improved bio-efficacy of a protease supplied in the animal's diet.

By “increased feed efficiency” it is meant that the use of a protease-containing feed additive composition, feed, or diet according the present invention in feed results in an increased weight gain per unit of feed intake compared with an animal fed without said protease-containing feed additive composition, feed, or diet being present.

As used herein, the term “feed conversion ratio” refers to the amount of feed fed to an animal to increase the weight of the animal by a specified amount. An improved feed conversion ratio means a lower feed conversion ratio. By “lower feed conversion ratio” or “improved feed conversion ratio” it is meant that the use of a protease-containing feed additive composition, feed, or diet in feed results in a lower amount of feed being required to be fed to an animal to increase the weight of the animal by a specified amount compared to the amount of feed required to increase the weight of the animal by the same amount when the feed does not comprise said protease-containing feed additive composition, feed, or diet.

As used here in the term “direct fed microbial” (DFM) refers to a composition for consumption by animals (i.e. as an or as a component of animal feed) that contains viable microorganisms, i.e. microorganisms that are capable of living and reproducing. See, for example, U.S. Pat. No. 8,420,074. A direct fed microbial may comprise one or more (such as any of 1, 2, 3, 4, 5, or 6 or more) of any of the microbial strains described herein. The terms “probiotic,” “probiotic culture,” and “DFM” are used interchangeably herein and define live microorganisms (including bacteria or yeasts for example) which, when for example ingested or locally applied in sufficient numbers, beneficially affects the host organism, i.e. by conferring one or more demonstrable health benefits on the host organism such as a health, digestive, and/or performance benefit. Probiotics may improve the microbial balance in one or more mucosal surfaces. For example, the mucosal surface may be the intestine, the urinary tract, the respiratory tract or the skin. The term “probiotic” as used herein also encompasses live microorganisms that can stimulate the beneficial branches of the immune system and at the same time decrease the inflammatory reactions in a mucosal surface, for example the gut. Whilst there are no lower or upper limits for probiotic intake, it has been suggested that at least 10⁶-10¹², such as at least 10⁶-10¹⁰, such as 10⁸-10⁹, cfu as a daily dose will be effective to achieve the beneficial health effects in a subject.

The term “CFU” as used herein means “colony forming units” and is a measure of viable cells in which a colony represents an aggregate of cells derived from a single progenitor cell.

The term “isolated” means a substance in a form or environment that does not occur in nature and does not reflect the extent to which an isolate has been purified buts indicates isolation or separation from a native form or native environment. Non-limiting examples of isolated substances include (1) any non-naturally occurring substance, (2) any substance including, but not limited to, any cell (such as a host cell), enzyme, engineered enzyme, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated.

The term “percent identity” is a relationship between two or more polypeptide sequences or two or more polynucleotide sequences, as determined by comparing the sequences. In the art, “identity” also means the degree of sequence relatedness between polypeptide or polynucleotide sequences, as the case may be, as determined by the number of matching nucleotides or amino acids between strings of such sequences. “Identity” and “similarity” can be readily calculated by known methods, including but not limited to those described in: Computational Molecular Biology (Lesk, A. M., ed.) Oxford University Press, NY (1988); Biocomputing: Informatics and Genome Projects (Smith, D. W., ed.) Academic Press, NY (1993); Computer Analysis of Sequence Data, Part I (Griffin, A. M., and Griffin, H. G., eds.) Humana Press, NJ (1994); Sequence Analysis in Molecular Biology (von Heinje, G., ed.) Academic Press (1987); and Sequence Analysis Primer (Gribskov, M. and Devereux, J., eds.) Stockton Press, NY (1991). Methods to determine identity and similarity are codified in publicly available computer programs. Percent identity may be determined using standard techniques known in the art. Useful algorithms include the BLAST algorithms (See, Altschul et al., J Mol Biol, 215:403-410, 1990; and Karlin and Altschul, Proc Natl Acad Sci USA, 90:5873-5787, 1993). The BLAST program uses several search parameters, most of which are set to the default values. The NCBI BLAST algorithm finds the most relevant sequences in terms of biological similarity but is not recommended for query sequences of less than 20 residues (Altschul et al., Nucleic Acids Res, 25:3389-3402, 1997; and Schaffer et al., Nucleic Acids Res, 29:2994-3005, 2001). Exemplary default BLAST parameters for a nucleic acid sequence searches include: Neighboring words threshold=11; E-value cutoff=10; Scoring Matrix=NUC.3.1 (match=1, mismatch=−3); Gap Opening=5; and Gap Extension=2. Exemplary default BLAST parameters for amino acid sequence searches include: Word size=3; E-value cutoff=10; Scoring Matrix=BLOSUM62; Gap Opening=11; and Gap extension=1.

As used herein with regard to nucleotide or amino acid residue positions, “corresponding to” or “corresponds to” or “correspond to” or “corresponds” refers to (i) a nucleotide or an amino acid residue at an enumerated position in a nucleic acid or a protein or peptide; or (ii) a nucleic acid or an amino acid residue that is analogous, homologous, or equivalent to an enumerated residue in a nucleic acid or a protein or peptide. As used herein, “corresponding region” generally refers to an analogous position in a related protein or a reference protein.

As used herein “administer” or “administering” is meant the action of introducing one or more microbial strain, an exogenous feed enzyme and/or a strain and an exogenous feed enzyme to an animal, such as by feeding or by gavage.

As used herein, the term “feed” is used synonymously herein with “feedstuff,” “animal feed composition,” and “fodder.” Feed broadly refers to a material, liquid or solid, that is used for nourishing an animal, and for sustaining normal or accelerated growth of an animal including newborns or young and developing animals. The term includes a compound, preparation, mixture, or composition suitable for intake by an animal (such as, e.g., ruminants such as cattle). In some embodiments, a feed or feed composition comprises a basal food composition and one or more feed additives or protease-containing feed additive compositions, feeds, or diets. The term “feed additive” as used herein refers to components included for purposes of fortifying basic feed with additional components to promote feed intake, treat or prevent disease, or alter metabolism. Feed additives include pre-mixes. As used herein, the term “food” is used in a broad sense—and covers food and food products in any form for humans as well as food for animals (i.e. a feed).

A “premix,” as referred to herein, may be a composition composed of micro-ingredients such as vitamins, minerals, chemical preservatives, antibiotics, fermentation products, and other essential ingredients. Premixes are usually compositions suitable for blending into commercial rations.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number can be a number which, in the context in which it is presented, provides the substantial equivalent of the specifically recited number. For example, in connection with a numerical value, the term “about” refers to a range of −10% to +10% of the numerical value, unless the term is otherwise specifically defined in context.

As used herein, the singular terms “a,” “an,” and “the” include the plural reference unless the context clearly indicates otherwise.

As used herein, “optional” or “optionally” means that the subsequently circumstance or limitation on scope does or does not occur, and that the description includes instances where the circumstance or limitation on scope occurs and instances where it does not. For example, an a composition that optionally contains additional exogenous enzymes means that the enzymes can be present or not present in the composition.

It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

It is also noted that the term “consisting essentially of,” as used herein refers to a composition wherein the component(s) after the term is in the presence of other known component(s) in a total amount that is less than 30% by weight of the total composition and do not contribute to or interferes with the actions or activities of the component(s).

It is further noted that the term “comprising,” as used herein, means including, but not limited to, the component(s) after the term “comprising.” The component(s) after the term “comprising” are required or mandatory, but the composition comprising the component(s) can further include other non-mandatory or optional component(s).

It is also noted that the term “consisting of,” as used herein, means including, and limited to, the component(s) after the term “consisting of.” The component(s) after the term “consisting of” are therefore required or mandatory, and no other component(s) are present in the composition.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Unless defined otherwise herein, all technical and scientific terms used herein have the same meaning as commonly understood by one of ordinary skill in the art to which this invention pertains.

Other definitions of terms may appear throughout the specification.

### II. Compositions

A. Feeds and Diets

As described in the Examples section, a series of six animal trials were performed to assess the bio-efficacy of proteases in several diets. It was found that putting constraints on one or more of four specific dietary parameters was associated with improvements in animal performance such as, without limitation, one or more of body weight gain, feed intake, and/or feed conversion ratio.

1. Soybean Meal Content

Soybean meal is used in food and animal feeds, principally as a protein supplement, but also as a source of metabolizable energy. Globally, about 98% of soybean meal is used as animal feed. Of total U.S. soybean production from 2010 through 2012, about 44% was exported as soybeans, and 53% was crushed in the U.S. Of the crushed tonnage, 19% was recovered as soybean oil and the remainder was recovered as soybean meal. Of the total U.S. soybean tonnage produced, about 35% was fed to U.S. livestock and poultry as soybean meal. It has been estimated that, of soy meal fed to animals in the US, 48% is fed to poultry, 26% to swine, 12% to beef cattle, 9% to dairy cattle, 3% is used in fish feed, and about 2% in pet food. Soybean meal is typically used in conjunction with low-protein feeds as an important supplement to ensure adequate protein intake.

Typically, a bushel (i.e. 60 lbs. or 27.2 kg) of soybeans yields 48 lbs. (21.8 kg) of soybean meal. Some, but not all, soybean meal is produced from the residue left after oil extraction. Removal of the oil, which is used mostly in food, but also for industrial oils, soaps and biodiesel, involves crushing and either pressing or solvent extraction. Some, but not all, soybean meal contains ground soybean hulls. Soybean meal is heat-treated during production, to denature the trypsin inhibitors of soybeans, which would otherwise interfere with protein digestion.

Three main kinds of soybean meal are produced: full-fat soybean meal; defatted soybean meal without hulls; and defatted soybean meal with hulls.

Full-fat soybean meal, made from whole soybeans, has a high metabolizable energy concentration (e.g., metabolizable energy for swine in this product is about 3.69 megacalories (i.e. 15.4 MJ) per kg dry matter). Crude protein concentration is about 38% (as fed). This kind of product is sometimes fed to various classes of livestock.

Defatted soybean meal containing no hulls has an intermediate energy concentration (e.g., metabolizable energy for swine in this product is about 3.38 megacalories (i.e. 14.1 MJ) per kg dry matter). Crude protein concentration is about 48%. This percentage is calculated at the typical as-fed dry matter content of 88%. Thus, crude protein concentration expressed on a dry matter basis is 54%. This product is commonly fed to swine, broilers and layers.

Defatted soybean meal can contain soybean hulls which are readily digestible by, for example, ruminant livestock. This product is often fed as a protein supplement for domestic ruminants. Ruminant-metabolizable energy concentration is about 3.0 megacalories (i.e. about 12.5 MJ) per kg dry matter, and crude protein concentration is about 44%. The latter percentage is calculated at the typical as-fed dry matter content of 90%. Thus, crude protein concentration on a dry matter basis is around 49%.

In some embodiments, the protease containing feeds or diets disclosed herein comprise a soybean meal having an acid detergent fiber (ADF) content greater than about 56 g/kg (such as greater than about 57 g/kg, 58 g/kg, 59 g/kg, 60 g/kg, 61 g/kg, 62 g/kg, 63 g/kg, 64 g/kg, 65 g/kg, 66 g/kg or more). The ADF of soybean meal content can be determined according to any means known in the art, including that described in Example 7.

In additional embodiments, the protease containing feeds or diets disclosed herein comprise a soybean meal having a sulfur-containing amino acid content of less than about 13 g/kg, such as less than about 12 g/kg or 11 g/kg. Sulfur-containing amino acid content can be determined according to any means known in the art, including that described in Example 8.

In some embodiments, protease-containing feeds or diets containing soybean meal with greater than about 56 g/kg ADF content and/or less than about 13 g/kg sulfur-containing amino acid content can lead to a higher likelihood or greater consistency with respect to the ability of the protease to improve animal performance in one or more parameters by greater than about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% compared to a protease-containing feed or diet that does not contain a soybean meal with greater than about 56 g/kg ADF content and/or less than about 13 g/kg sulfur-containing amino acid content. In some embodiments, improved animal performance is determined by a parameter than can include, without limitation, increased weight gain and/or decreased feed conversion ratio.

2. Particle Size

Protease-containing feeds or diets for increasing protease efficacy as disclosed herein have a higher protease bio-efficacy when the majority of the feed stuff (such as at least 50% or more, such as any of 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%) has a particle size of less than about 1 mm (such as less than any of about 950 μm, 900 μm, 850 μm, 800 μm, 750 μm, 700 μm, 650 μm, 600 μm, 550 μm, 500 μm, 450 μm, 400 μm, 350 μm, 300 μm, 250 μm, 200 μm, 150 μm, 100 μm or less, including all values falling in between these sizes).

Particle sizes of less than about 1 mm may be produced by any means known in the art including, without limitation, by a process selected from the group consisting of grinding, milling, pulverizing, lyophilization, high shear granulation, drum granulation, drum drying, extrusion, spheronization, fluidized bed agglomeration, fluidized bed spray coating, spray drying, spray cooking, freeze drying, prilling, spray chilling, spinning disk atomization, coacervation, tableting, or any combination of the above processes. Particle size and percentage of particle size having a size of less than about 1 mm in a feedstuff can be determined by any means known in the art, including that described in Example 9.

In some embodiments, protease-containing feeds or diets having a particle size of less than about 1 mm can lead to a higher likelihood or greater consistency with respect to the ability of the protease to improve animal performance in one or more parameters by greater than about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% compared to protease-containing feeds or diets that do not have a particle size of less than about 1 mm. In some embodiments, the protease-containing feeds or diets optionally can also include soybean meal having greater than about 56 g/kg ADF content and/or less than about 13 g/kg sulfur-containing amino acid content. In some embodiments, improved animal performance is determined by a parameter than can include, without limitation, increased weight gain and/or decreased feed conversion ratio.

3. Buffer Capacity

The protease containing feeds or diets disclosed herein can be formulated to have a low buffer capacity to improve protease bio-efficacy. In some embodiments, a feed or diet has a low buffer capacity when the stabilized pH following moderate acid addition to a suspension of the animal feed is less than about 4.2 (such as less than about 4.1, 4, 3.9, 3.8, 3.7, 3.6, or 3.5). In another embodiment, a feed or diet has a low buffer capacity when the stabilized pH after addition of 0.3 mol/kg HCl to a 10% suspension of the animal feed is less than about 4.2 (such as less than about 4.1, 4, 3.9, 3.8, 3.7, 3.6, or 3.5). In still further embodiments, a feed or diet has a low buffer capacity when less than about 0.44 mol/kg (such as less than about 0.43 mol/kg, 0.42 mol/kg, 0.41 mol/kg, 0.4 mol/kg, 0.39 mol/kg, 0.38 mol/kg, 0.37 mol/kg, 0.36 mol/kg, or 0.35 mol/kg) HCl is added to reach a pH-value of 4.0. Buffer capacity can be determined by any means known in the art including the method described in Example 10.

In some embodiments, protease-containing feeds or diets having a low buffer capacity can lead to a higher likelihood or greater consistency with respect to the ability of the protease to improve animal performance in one or more parameters by greater than about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% compared to protease-containing feeds or diets that do not have low buffer capacity. In some embodiments, the protease-containing feeds or diets optionally can also include a soybean meal with greater than about 56 g/kg ADF content and/or less than about 13 g/kg sulfur-containing amino acid content and/or a majority of feed or diet particle sizes less than about 1 mm. In some embodiments, improved animal performance is determined by a parameter than can include, without limitation, increased weight gain and/or decreased feed conversion ratio.

4. Proteases

The term “protease” as used herein is synonymous with peptidase or proteinase. The protease suitable for use in any of the protease-containing feed additive compositions, feeds, or diets disclosed herein may be a subtilisin (E.C. 3.4.21.62) or a bacillolysin (E.C. 3.4.24.28) or an alkaline serine protease (E.C. 3.4.21.x) or a keratinase (E.C. 3.4.X.X). In one embodiment, the protease is a subtilisin. Suitable proteases include those of animal, vegetable or microbial origin. Chemically modified or protein engineered mutants (such as mutants engineered for increased thermostability, increased activity, or increased pH tolerance) are also suitable. The protease may be a serine protease or a metalloprotease. e.g., an alkaline microbial protease or a trypsin-like protease.

Examples of alkaline proteases are subtilisins, especially those derived from Bacillus sp., e.g., subtilisin Novo, subtilisin Carlsberg, subtilisin 309 (see, e.g., U.S. Pat. No. 6,287,841), subtilisin 147, and subtilisin 168 (see, e.g., WO 89/06279). Examples of trypsin-like proteases are trypsin (e.g., of porcine or bovine origin), and Fusarium proteases (see, e.g., WO 89/06270 and WO 94/25583). Examples of useful proteases also include but are not limited to the variants described in WO 92/19729 and WO 98/20115.

In another embodiment, the protease may be one or more of the proteases in one or more of the commercial products recited in Table 11.

TABLE 11
Representative commercial proteases
Representative examples of commercial proteases.

| Commercial product ® | Company | Protease type | Protease source |
|---|---|---|---|
| Avizyme 1100 | Danisco A/S | Subtilisin | Bacillus subtilis |
| Avizyme 1202 | Danisco A/S | Subtilisin | Bacillus subtilis |
| Avizyme 1302 | Danisco A/S | Subtilisin | Bacillus subtilis |
| Avizyme 1500 | Danisco A/S | Subtilisin | Bacillus subtilis |
| Avizyme 1505 | Danisco A/S | Subtilisin | Bacillus subtilis |
| Kemzyme Plus Dry | Kemin | Bacillolysin | Bacillus amyloliquefaciens |
| Kemzyme W dry | Kemin | Bacillolysin | Bacillus amyloliquefaciens |
| Natuzyme | Bioproton | Protease | Trichoderma longibrachiatum/ |
| | | | Trichoderma reesei |
| Porzyme 8300 | Danisco | Subtilisin | Bacillus subtilis |
| Ronozyme ProAct | DSM/Novozymes | Alkaline | Nacardiopsis prasina gene |
| | | serine protease | expressed in Bacillus licheniformis |
| Versazyme/ | Novus | Keratinase | Bacillus licheniformis |
| Cibenza DP100 | | | |

In one embodiment, the protease is selected from the group consisting of subtilisin, a bacillolysin, an alkine serine protease, a keratinase, and a Nocardiopsis protease.

In some embodiments, the protease shares at least about 80% amino acid sequence identity (such as any of about 80%, 81%, 82%, 83%, 84%, 85%, 86%, 87%, 88%, 89%, 90%, 91%, 92%, 93%, 94%, 95%, 96%, 97%, 98%, 99%, or 100% sequence identity) to the protease of SEQ ID NO:1. In another embodiment, the protease shares at least about 80% amino acid sequence identity (such as any of about 80%, 81%, 82%, 83%, 84%, 85%, 86%, 87%, 88%, 89%, 90%, 91%, 92%, 93%, 94%, 95%, 96%, 97%, 98%, 99%, or 100% sequence identity) to a nucleic acid encoding the polypeptide of SEQ ID NO:1.

It will be understood that one protease unit (PU) is the amount of enzyme that liberates from the substrate (0.6% casein solution) one microgram of phenolic compound (expressed as tyrosine equivalents) in one minute at pH 7.5 (40 mM Na₂PO₄/lactic acid buffer) and 40° C. This may be referred to as the assay for determining 1 PU.

In one embodiment, the feed additive composition comprises 500-1000, 1000-2500, 2500-5000, 5000-10000, 10000-25000, 25000-50000, 50000-75000, 75000-100000, 100000-125000, 125000-150000, 150000-175000, 175000-200000 and greater than 200000 protease units/g feed additive composition.

In one embodiment, the feed, feed additive composition, or diet comprises 500-1000, 1000-1500, 1500-2000, 2000-2500, 2500-3000, 3000-3500, 3500-4000, 4000-4500, 4500-5000, 5000-5500, 5500-6000, 6000-6500, 6500-7000, 7000-7500, 7500-8000, 8000-8500, 8500-9000, 9000-9500, 9500-10000, 10000-11000, 11000-12000, 12000-13000, 13000-14000, 14000-15000 and greater than 15000 protease units/g feed, feed additive composition, or diet, or added to the drinking water.

B. Additional Exogenous Enzymes

Supplemental enzymes can be used as additives to feed additive compositions, animal feed, and diets, particularly poultry and swine feeds, as a means to improve nutrient utilization and performance characteristics.

In one embodiment, the disclosure relates to a composition comprising a protease-containing feed additive composition, feed, or diet characterized by one or more of a soybean meal having an acid detergent fiber (ADF) content greater than about 56 g/kg; a soybean meal having a sulfur-containing amino acid content of less than about 13 g/kg; a majority of particles comprising less than 1 mm in size; and/or low buffer capacity as well as one or more exogenous feed enzymes. Exogenous feed enzymes can include, but are not limited to, xylanase, amylase, phytase, beta-glucanase, pectinase, mannanase, and additional proteases.

1. Xylanases

Xylanase is the name given to a class of enzymes that degrade the linear polysaccharide β-1,4-xylan into xylose, thus breaking down hemicellulose, one of the major components of plant cell walls. Xylanases, e.g., endo-β-xylanases (EC 3.2.1.8) hydrolyze the xylan backbone chain. In one embodiment, provided herein are compositions comprising any of the protease-containing feed additive compositions, feeds, or diets disclosed herein and one or more xylanase.

In one embodiment, the xylanase may be any commercially available xylanase. Suitably the xylanase may be an endo-1,4-P-d-xylanase (classified as EC 3.2.1.8) or a 1,4β-xylosidase (classified as EC 3.2.1.37). In one embodiment, the disclosure relates to a DFM in combination with an endoxylanase, e.g. an endo-1,4-P-d-xylanase, and another enzyme. All E.C. enzyme classifications referred to herein relate to the classifications provided in Enzyme Nomenclature—Recommendations (1992) of the nomenclature committee of the International Union of Biochemistry and Molecular Biology—ISBN 0-12-226164-3, which is incorporated herein

In another embodiment, the xylanase may be a xylanase from Bacillus, Trichodermna, Therinomyces, Aspergillus and Penicillium. In still another embodiment, the xylanase may be the xylanase in Axtra XAP® or Avizyme 1502®, both commercially available products from Danisco A/S. In one embodiment, the xylanase may be a mixture of two or more xylanases. In still another embodiment, the xylanase is an endo-1,4-β-xylanase or a 1,4-β-xylosidase. In yet another embodiment, the xylanase is from an organism selected from the group consisting of: Bacillus, Trichoderma, Thermomyces, Aspergillus, Penicillium, and Humicola. In yet another embodiment, the xylanase may be one or more of the xylanases or one or more of the commercial products recited in Table 12.

TABLE 12
Representative commercial xylanases
Representative examples of commercial xylanases.

| Commercial Name ® | Company | Xylanase type | Xylanase source |
|---|---|---|---|
| Allzyme PT | Alltech | endo-1,4-β-xylanase | Aspergillus Niger |
| Amylofeed | Andrés | endo-1,4-β-xylanase | Aspergillus Niger (phoenicis) |
| | Pintaluba S.A | | |
| Avemix 02 CS | Aveve | endo-1,4-β-xylanase | Trichoderma reesei |
| AveMix XG 10 | Aveve, NL | endo-1,4-β-xylanase | Trichoderma reesei |
| Avizyme 1100 | Danisco | endo-1,4-β-xylanase | Trichoderma longibrachiatum |
| Avizyme 1110 | Danisco | endo-1,4-β-xylanase | Trichoderma longibrachiatum |
| Avizyme 1202 | Danisco | endo-1,4-β-xylanase | Trichoderma longibrachiatum |
| Avizyme 1210 | Danisco | endo-1,4-β-xylanase | Trichoderma longibrachiatum |
| Avizyme 1302 | Danisco | endo-1,4-β-xylanase | Trichoderma longibrachiatum |
| Avizyme 1500 | Danisco | endo-1,4-β-xylanase | Trichoderma longibrachiatum |
| Avizyme 1505 | Danisco | endo-1,4-β-xylanase | Trichoderma longibrachiatum |
| Avizyme SX | Danisco | endo-1,4-β-xylanase | Trichoderma longibrachiatum |
| Belfeed MP 100 | Beldem | endo-1,4-β-xylanase | Bacillus subtilis |
| Biofeed Plus | DSM | endo-1,4-β-xylanase | Humicola insolens |
| Danisco Glycosidase | Danisco Animal | endo-1,4-β-xylanase | Trichoderma reesei |
| (TPT/L) | Nutrition | | |
| Danisco Xylanase | Danisco | endo-1,4-β-xylanase | Trichoderma reesei |
| Econase XT | AB Vista | endo-1,4-β-xylanase | Trichoderma reesei |
| Endofeed ® DC | Andrés | endo-1,4-β-xylanase | Aspergillus Niger |
| | Pintaluba S.A. | | |
| Feedlyve AXL | Lyven | endo-1,4-β-xylanase | Trichoderma longibrachiatum |
| Grindazym GP | Danisco | endo-1,4-β-xylanase | Aspergillus Niger |
| Grindazym GV | Danisco | endo-1,4-β-xylanase | Aspergillus Niger |
| Hostazym X | Huvepharma | endo-1,4-β-xylanase | Trichoderma longibrachiatum |
| Kemzyme Plus Dry | Kemin | endo-1,4-β-xylanase | Trichoderma viride |
| Kemzyme Plus Liquid | Kemin | endo-1,4-β-xylanase | Trichoderma viride |
| Kemzyme W dry | Kemin | endo-1,4-β-xylanase | Trichoderma viride |
| Kemzyme W liquid | Kemin | endo-1,4-β-xylanase | Trichoderma viride |
| Natugrain | BASF | endo-1,4-β-xylanase | Trichoderma longibrachiatum |
| Natugrain TS Plus | BASF | endo-1,4-β-xylanase | Aspergillus Niger |
| Natugrain Wheat | BASF | endo-1,4-β-xylanase | Aspergillus Niger |
| Natugrain ® TS/L | BASF | endo-1,4-β-xylanase | Aspergillus Niger |
| Natuzyme | Bioproton | endo-1,4-β-xylanase | Trichoderma longibrachiatum/ |
| | | | Trichoderma reesei |
| Porzyme 8100 | Danisco | endo-1,4-β-xylanase | Trichoderma longibrachiatum |
| Porzyme 8300 | Danisco | endo-1,4-β-xylanase | Trichoderma longibrachiatum |
| Porzyme 9102 | Danisco | endo-1,4-β-xylanase | Trichoderma longibrachiatum |
| Porzyme 9310/ | Danisco | endo-1,4-β-xylanase | Trichoderma longibrachiatum |
| Avizyme 1310 | | | |
| Porzyme ip 100 | Danisco | endo-1,4-β-xylanase | Trichoderma longibrachiatum |
| Ronozyme AX | DSM | endo-1,4-β-xylanase | Thermomyces lanuginosus gene |
| | | | expressed in Aspergillus oryzae |
| Ronozyme WX | DSM/Novozymes | endo-1,4-β-xylanase | Thermomyces lanuginosus gene |
| | | | expressed in Aspergillus oryzae |
| Rovabio Excel | Adisseo | endo-1,4-β-xylanase | Penicillium funiculosum |
| Roxazyme G2 | DSM/Novozymes | endo-1,4-β-xylanase | Trichoderma longibrachiatum |
| Safizym X | Le Saffre | endo-1,4-β-xylanase | Trichoderma longibrachiatum |
| Xylanase | Lyven | endo-1,4-β-xylanase | Trichoderma longibrachiatum |

In one embodiment, the disclosure relates to a composition comprising a protease-containing feed additive composition, feed, or diet (such as any of those described herein for increasing protease bio-efficacy) and a xylanase. In one embodiment, the composition comprises 1000-5000, 5000-10000, 10000-15000, 15000-20000, 20000-25000, 25000-30000, 30000-40000, 40000-50000, 50000-60000,60000-70000, 70000-80000, 80000-90000, 90000-100000, 100000-125000, 125000-150000 and greater than 150000 xylanase units/g of feed additive composition.

In one embodiment, the protease-containing feed additive composition, feed, or diet comprises 500-1000, 1000-1500, 1500-2000, 2000-2500, 2500-3000, 3000-3500, 3500-4000, 4000-4500, 4500-5000, 5000-5500, 5500-6000, 6000-6500, 6500-7000, 7000-7500, 7500-8000, 8000-9000, 9000-10000 and greater than 10000 xylanase units/kg feed additive composition, feed, or diet.

It will be understood that one xylanase unit (XU) is the amount of enzyme that releases 0.5 μmol of reducing sugar equivalents (as xylose by the Dinitrosalicylic acid (DNS) assay-reducing sugar method) from an oat-spelt-xylan substrate per min at pH 5.3 and 50° C. (Bailey, et al., Journal of Biotechnology, Volume 23, (3), May 1992, 257-270).

2. Amylases

Amylase is a class of enzymes capable of hydrolysing starch to shorter-chain oligosaccharides, such as maltose. The glucose moiety can then be more easily transferred from maltose to a monoglyceride or glycosylmonoglyceride than from the original starch molecule. The term amylase includes α-amylases (E.C. 3.2.1.1), G4-forming amylases (E.C. 3.2.1.60), β-amylases ((E.C. 3.2.1.2) and 7-amylases (E.C. 3.2.1.3). Amylases may be of bacterial or fungal origin, or chemically modified or protein engineered mutants. In one embodiment, provided herein are compositions comprising any of the protease-containing feed additive compositions, feeds, or diets disclosed herein and one or more amylase.

In one embodiment, the amylase may be a mixture of two or more amylases. In another embodiment, the amylase may be an amylase, e.g. an α-amylase, from Bacillus licheniformis and an amylase, e.g. an α-amylase, from Bacillus amyloliquefaciens. In one embodiment, the α-amylase may be the α-amylase in Axtra XAP® or Avizyme 1502®, both commercially available products from Danisco A/S. In yet another embodiment, the amylase may be a pepsin resistant α-amylase, such as a pepsin resistant Trichoderma (such as Trichoderma reesei) alpha amylase. A suitably pepsin resistant α-amylase is taught in UK application number 101 1513.7 (which is incorporated herein by reference) and PCT/IB2011/053018 (which is incorporated herein by reference).

In one embodiment, the amylase for use in the present invention may be one or more of the amylases in one or more of the commercial products recited in Table 13.

TABLE 13
Representative commercial amylases
Representative examples of commercial amylases.

| Commercial product ® | Company | Amylase type | Amylase source |
|---|---|---|---|
| Amylofeed | Andrés | alpha amylase | Aspergillus oryzae |
| | Pintaluba S.A | | |
| Avizyme 1500 | Danisco | alpha amylase | Bacillus amyloliquefaciens |
| Avizyme 1505 | Danisco | alpha amylase | Bacillus amyloliquefaciens |
| Kemzyme Plus Dry | Kemin | alpha-amylase | Bacillus amyloliquefaciens |
| Kemzyme Plus Liquid | Kemin | alpha-amylase | Bacillus amyloliquefaciens |
| Kemzyme W dry | Kemin | alpha-amylase | Bacillus amyloliquefaciens |
| Kemzyme W liquid | Kemin | alpha-amylase | Bacillus amyloliquefaciens |
| Natuzyme | Bioproton | alpha-amylase | Trichoderma longibrachiatum/ |
| | | | Trichoderma reesei |
| Porzyme 8100 | Danisco | alpha-amylase | Bacillus amyloliquefaciens |
| Porzyme ip100 | Danisco | alpha-amylase | Bacillus amyloliquefaciens |
| Ronozyme A | DSM/Novozymes | alpha-amylase | Bacillus amyloliquefaciens |
| Ronozyme AX | DSM | alpha-amylase | Bacillus amyloliquefaciens |
| Ronozyme ® | DSM/Novozymes | alpha-amylase | Bacillus stearothermophilus |
| RumiStar (L/CT) | | | expressed in Bacillus licheniformis |

It will be understood that one amylase unit (AU) is the amount of enzyme that (in the presence of excess alpha-glucosidase) releases 0.2 μmol of glucosidic linkages (expressed as p-nitrophenol equivalents) from p-nitrophenyl maltoheptoside with the non-reducing terminal sugar chemically blocked (BPNPG7) per min at pH 8.0 and 40° C. (this may be referred to herein as the assay for determining 1 AU).

In one embodiment, the disclosure relates to a composition comprising a protease-containing feed additive composition, feed, or diet (such as any of those described herein for increasing protease bio-efficacy) and an amylase. In one embodiment, disclosure relates to a composition comprising a protease-containing feed additive composition, feed, or diet (such as any of those described herein for increasing protease bio-efficacy), a xylanase and an amylase. In one embodiment, the composition comprises 500-1000, 1000-2000, 2000-3000, 3000-4000, 4000-5000, 5000-6000, 6000-7000, 7000-8000, 8000-9000, 9000-10000, 10000-12500, 12500-15000, 15000-17500, 17500-20000 and greater than 20000 amylase units/g feed additive composition.

In one embodiment, the protease-containing feed additive composition, feed, or diet comprises 10-50, 50-100, 100-150, 150-200, 200-250, 250-300, 300-350, 350-400, 400-450, 450-500, 500-550, 550-600, 600-650, 650-700, 700-750, 750-1000 and greater than 1000 amylase units/kg feed additive composition, feed, or diet.

4. Phytases

In one embodiment, provided herein are compositions comprising any of the protease-containing feed additive compositions, feeds, or diets disclosed herein and one or more phytase. The phytase for use in the present invention may be classified a 6-phytase (classified as E.C. 3.1.3.26) or a 3-phytase (classified as E.C. 3.1.3.8). In one embodiment, the phytase for use in the present invention may be one or more of the phytases in one or more of the commercial products below in Table 14:

TABLE 14
Representative commercial phytases

| Commercial product ® | Company | Phytase type | Phytase source |
|---|---|---|---|
| Finase | ABVista | 3-phytase | Trichoderma reesei |
| Finase EC | ABVista | 6-phytase | E. coli gene expressed in |
| | | | Trichoderma reesei |
| Natuphos | BASF | 3-phytase | Aspergillus Niger |
| Natuzyme | Bioproton | phytase (type | Trichoderma longibrachiatum/ |
| | | not specified) | Trichoderma reesei |
| OPTIPHOS ® | Huvepharma AD | 6-phytase | E. coli gene expressed in |
| | | | Pichia pastoris |
| Phytase sp1002 | DSM | 3-phytase | A consensus gene expressed in |
| | | | Hansenula polymorpha |
| Phyzyme XP | Danisco | 6-phytase | E. coli gene expressed in |
| | | | Schizosaccahomyces pombe |
| Quantum 2500D, | ABVista | 6-phytase | E. coli gene expressed in |
| 5000L | | | Pichia pastoris or Trichoderma |
| Ronozyme Hi-Phos | DSM/Novozymes | 6-phytase | Citrobacter braakii gene |
| (M/L) | | | expressed in Asperigillus oryzae |
| Ronozyme NP | DSM/Novozymes | 6-phytase | Peniphora lycii gene |
| | | | expressed in Asperigillus oryzae |
| Ronozyme P | DSM/Novozymes | 6-phytase | Peniphora lycii gene |
| | | | expressed in Asperigillus oryzae |
| Rovabio PHY | Adisseo | 3-phytase | Penicillium funiculosum |

In one embodiment the phytase is a Citrobacter phytase derived from e.g. Citrobacter freundii, preferably C. freundii NCIMB 41247 and variants thereof e.g. as disclosed in WO2006/038062 (incorporated herein by reference) and WO2006/038128 (incorporated herein by reference), Citrobacter braakii YH-15 as disclosed in WO 2004/085638, Citrobacter braakii ATCC 51113 as disclosed in WO2006/037328 (incorporated herein by reference), as well as variants thereof e.g. as disclosed in WO2007/112739 (incorporated herein by reference) and WO2011/117396 (incorporated herein by reference), Citrobacter amalonaticus, preferably Citrobacter amalonaticus ATCC 25405 or Citrobacter amalonaticus ATCC 25407 as disclosed in WO2006037327 (incorporated herein by reference), Citrobacter gillenii, preferably Citrobacter gillenii DSM 13694 as disclosed in WO2006037327 (incorporated herein by reference), or Citrobacter intermedius, Citrobacter koseri, Citrobacter murliniae, Citrobacter rodentium, Citrobacter sedlakii, Citrobacter werkmanii, Citrobacter youngae, Citrobacter species polypeptides or variants thereof.

In some embodiments, the phytase is an E. coli phytase marketed under the name Phyzyme XP™ Danisco A/S. Alternatively, the phytase may be a Buttiauxella phytase, e.g. a Buttiauxella agrestis phytase, for example, the phytase enzymes taught in WO 2006/043178, WO 2008/097619, WO2009/129489, WO2008/092901, PCT/US2009/41011 or PCT/IB32010/051804, all of which are incorporated herein by reference. In yet another embodiment, the phytase can be a phytase described in WO2020/106796, which is incorporated herein by reference in its entirety.

In one embodiment, the phytase may be a phytase from Hafnia, e.g. from Hafnia alvei, such as the phytase enzyme(s) taught in US2008263688, which reference is incorporated herein by reference. In one embodiment, the phytase may be a phytase from Aspergillus, e.g. from Apergillus orzyae. In one embodiment, the phytase may be a phytase from Penicillium, e.g. from Penicillium funiculosum.

Preferably, the phytase is present in the protease-containing feed additive compositions, feeds, or diets disclosed herein in range of about 200 FTU/kg to about 1000 FTU/kg feed, more preferably about 300 FTU/kg feed to about 750 FTU/kg feed, more preferably about 400 FTU/kg feed to about 500 FTU/kg feed. In one embodiment, the phytase is present in the protease-containing feed additive compositions, feeds, or diets disclosed herein at more than about 200 FTU/kg feed, suitably more than about 300 FTU/kg feed, suitably more than about 400 FTU/kg feed. In one embodiment, the phytase is present in the protease-containing feed additive compositions, feeds, or diets disclosed herein at less than about 1000 FTU/kg feed, suitably less than about 750 FTU/kg feed. Preferably, the phytase is present in the protease-containing feed additive compositions, feeds, or diets disclosed herein in range of about FTU/g to about 40,000 FTU/g composition, more preferably about 80 FTU/g composition to about 20,000 FTU/g composition, and even more preferably about 100 FTU/g composition to about 10,000 FTU/g composition, and even more preferably about 200 FTU/g composition to about 10,000 FTU/g composition. In one embodiment, the phytase is present in the protease-containing feed additive compositions, feeds, or diets disclosed herein at more than about 40 FTU/g composition, suitably more than about 60 FTU/g composition, suitably more than about 100 FTU/g composition, suitably more than about 150 FTU/g composition, suitably more than about 200 FTU/g composition. In one embodiment, the phytase is present in the protease-containing feed additive compositions, feeds, or diets disclosed herein at less than about 40,000 FTU/g composition, suitably less than about 20,000 FTU/g composition, suitably less than about 15,000 FTU/g composition, suitably less than about 10,000 FTU/g composition. In some embodiments, the dose rate of phytase comprises 1000-150000 FTU/g feed additive composition, and 100-10000 FTU/kg for feed and diets.

It will be understood that as used herein 1 FTU (phytase unit) is defined as the amount of enzyme required to release 1 μmol of inorganic orthophosphate from a substrate in one minute under the reaction conditions defined in the ISO 2009 phytase assay—A standard assay for determining phytase activity and 1 FTU can be found at International Standard ISO/DIS 30024: 1-17, 2009. In one embodiment, the enzyme is classified using the E.C. classification above, and the E.C. classification designates an enzyme having that activity when tested in the assay taught herein for determining 1 FTU.

In one embodiment, disclosure relates to protease-containing feed additive compositions, feeds, or diets disclosed herein and a xylanase. In still another embodiment, the disclosure relates to protease-containing feed additive compositions, feeds, or diets disclosed herein and an amylase. In still another embodiment, the disclosure relates to protease-containing feed additive compositions, feeds, or diets disclosed herein and a phytase. In still another embodiment, the disclosure relates to protease-containing feed additive compositions, feeds, or diets disclosed herein and a xylanase and an amylase. In still another embodiment, the disclosure relates to protease-containing feed additive compositions, feeds, or diets disclosed herein and a xylanase and a phytase. In still another embodiment, the disclosure relates to protease-containing feed additive compositions, feeds, or diets disclosed herein and an amylase and a phytase. In yet another embodiment, the disclosure relates to protease-containing feed additive compositions, feeds, or diets disclosed herein and an amylase, a xylanase, and a phytase.

C. DFM Formulations

Additionally, any of the protease-containing feed additive compositions, feeds, or diets disclosed herein can further be formulated in conjunction with one or more direct fed microbials (DFMs) or a fermentate of one or more DFMs. A DFM as described herein may comprise microorganisms from one or more of the following genera: Lactobacillus, Lactococcus, Streptococcus, Bacillus, Pediococcus, Enterococcus, Leuconostoc, Carnobacterium, Propionibacterium, Bifidobacterium, Clostridium and Megasphaera and combinations thereof.

In one embodiment, the DFM comprises one or more bacterial strains selected from the following Bacillus spp: Bacillus subtilis, Bacillus cereus, Bacillus licheniformis, Bacillus pumilis and Bacillus amyloliquefaciens.

The genus “Bacillus”, as used herein, includes all species within the genus “Bacillus,” as known to those of skill in the art, including but not limited to B. subtilis, B. licheniformis, B. lentus, B. brevis, B. stearothermophilus, B. alkalophilus, B. amyloliquefaciens, B. clausii, B. halodurans, B. megaterium, B. coagulans, B. circulans, B. gibsonii, B. pumilis and B. thuringiensis. It is recognized that the genus Bacillus continues to undergo taxonomical reorganization. Thus, it is intended that the genus include species that have been reclassified, including but not limited to such organisms as Bacillus stearothermophilus, which is now named “Geobacillus stearothermophilus”, or Bacillus polymyxa, which is now “Paenibacillus polymyxa” The production of resistant endospores under stressful environmental conditions is considered the defining feature of the genus Bacillus, although this characteristic also applies to the recently named Alicyclobacillus, Amphibacillus, Aneurinibacillus, Anoxybacillus, Brevibacillus, Filobacillus, Gracilibacillus, Halobacillus, Paenibacillus, Salibacillus, Thermobacillus, Ureibacillus, and Virgibacillus.

In another aspect, the protease-containing feed additive compositions, feeds, or diets disclosed herein may be further combined with the following Lactococcus spp: Lactococcus cremoris and Lactococcus lactis and combinations thereof.

The protease-containing feed additive compositions, feeds, or diets disclosed herein may be further combined with the following Lactobacillus spp: Lactobacillus buchneri, Lactobacillus acidophilus, Lactobacillus casei, Lactobacillus kefiri, Lactobacillus bifidus, Lactobacillus brevis, Lactobacillus helveticus, Lactobacillus paracasei, Lactobacillus rhamnosus, Lactobacillus salivarius, Lactobacillus curvatus, Lactobacillus bulgaricus, Lactobacillus sakei, Lactobacillus reuteri, Lactobacillus fermentum, Lactobacillus farciminis, Lactobacillus lactis, Lactobacillus delbreuckii, Lactobacillus plantarum, Lactobacillus paraplantarum, Lactobacillus farciminis, Lactobacillus rhamnosus, Lactobacillus crispatus, Lactobacillus gasseri, Lactobacillus johnsonii and Lactobacillus jensenii, and combinations of any thereof.

In still another aspect, the protease-containing feed additive compositions, feeds, or diets disclosed herein may be further combined with the following Bifidobacteria spp: Bifidobacterium lactis, Bifidobacterium bifidium, Bifidobacterium longum, Bifidobacterium animalis, Bifidobacterium breve, Bifidobacterium infantis, Bifidobacterium catenulatum, Bifidobacterium pseudocatenulatum, Bifidobacterium adolescentis, and Bifidobacterium angulatum, and combinations of any thereof.

Alternatively, protease-containing feed additive compositions, feeds, or diets disclosed herein may be combined with one or more of the products or the microorganisms contained in those products disclosed in WO2012110778, and summarized as follows: Bacillus subtilis strain 2084 Accession No. NRRLB-50013, Bacillus subtilis strain LSSAO1 Accession No. NRRL B-50104, and Bacillus subtilis strain 15A-P4 ATCC Accession No. PTA-6507 (from Enviva Pro®. (formerly known as Avicorr®); Bacillus subtilis Strain C3102 (from Calsporin®); Bacillus subtilis Strain PB6 (from Clostat®); Bacillus pumilis (8G-134); Enterococcus NCIMB 10415 (SF68) (from Cylactin®); Bacillus subtilis Strain C3102 (from Gallipro® & GalliproMax®); Bacillus licheniformis (from Gallipro® Tect®); Enterococcus and Pediococcus (from Poultry star®); Lactobacillus, Bifidobacterium and/or Enterococcus from Protexin®); Bacillus subtilis strain QST 713 (from Proflora®); Bacillus amyloliquefaciens CECT-5940 (from Ecobiol® & Ecobiol® Plus); Enterococcus faecium SF68 (from Fortiflora®); Bacillus subtilis and Bacillus licheniformis (from BioPlus2B®); Lactic acid bacteria 7 Enterococcus faecium (from Lactiferm®); Bacillus strain (from CSI®); Saccharomyces cerevisiae (from Yea-Sacc®); Enterococcus (from Biomin IMB52®); Pediococcus acidilactici, Enterococcus, Bifidobacterium animalis ssp. animalis, Lactobacillus reuteri, Lactobacillus salivarius ssp. salivarius (from Biomin C5e); Lactobacillus farciminis (from Biacton®); Enterococcus (from Oralin E1 707®); Enterococcus (2 strains), Lactococcus lactis DSM 1103(from Probios-pioneer PDFM®); Lactobacillus rhamnosus and Lactobacillus farciminis (from Sorbiflore®); Bacillus subtilis (from Animavit®); Enterococcus (from Bonvital®); Saccharomyces cerevisiae (from Levucell SB 20®); Saccharomyces cerevisiae (from Levucell SC 0 & SC10® ME); Pediococcus acidilacti (from Bactocell); Saccharomyces cerevisiae (from ActiSaf® (formerly BioSaf®)); Saccharomyces cerevisiae NCYC Sc47 (from Actisaf® SC47); Clostridium butyricum (from Miya-Gold®); Enterococcus (from Fecinor and Fecinor Plus®); Saccharomyces cerevisiae NCYC R-625 (from InteSwine®); Saccharomyces cerevisia (from BioSprint®); Enterococcus and Lactobacillus rhamnosus (from Provita®); Bacillus subtilis and Aspergillus oryzae (from PepSoyGen-C®); Bacillus cereus (from Toyocerin®); Bacillus cereus var. toyoi NCIMB 40112/CNCM 1-1012 (from TOYOCERIN®), or other DFMs such as Bacillus licheniformis and Bacillus subtilis (from BioPlus® YC) and Bacillus subtilis (from GalliPro®).

The protease-containing feed additive compositions, feeds, or diets disclosed herein may be combined with Enviva® PRO which is commercially available from Danisco A/S. Enviva Pro® is a combination of Bacillus strain 2084 Accession No. NRRL B-50013, Bacillus strain LSSAO1 Accession No. NRRL B-50104 and Bacillus strain 15A-P4 ATCC Accession No. PTA-6507 (as taught in U.S. Pat. No. 7,754,469 B—incorporated herein by reference).

Preferably, the additional DFM described herein comprises microorganisms which are generally recognized as safe (GRAS) and, preferably are GRAS-approved.

A person of ordinary skill in the art will readily be aware of specific species and/or strains of microorganisms from within the genera described herein which are used in the food and/or agricultural industries and which are generally considered suitable for animal consumption.

D. Feed Additive Compositions

In one embodiment, provided herein are protease-containing feed additive compositions for addition to any of the feeds or diets disclosed herein (such as those feeds or diets characterized by one or more of a soybean meal having an acid detergent fiber (ADF) content greater than about 56 g/kg; a soybean meal having a sulfur-containing amino acid content of less than about 13 g/kg; a majority of particles comprising less than 1 mm in size; and/or low buffer capacity) and, optionally, one or more exogenous feed enzymes and/or DFMs. In one embodiment, the feed additive composition can be formulated in any suitable way to ensure that the formulation comprises viable DFMs and, optionally, active enzymes.

In one embodiment, the protease-containing feed additive composition may be used in the form of solid or liquid preparations or alternatives thereof. Examples of solid preparations include powders, pastes, boluses, capsules, ovules, pills, pellets, tablets, dusts, and granules which may be wettable, spray-dried or freeze-dried. Examples of liquid preparations include, but are not limited to, aqueous, organic or aqueous-organic solutions, suspensions and emulsions.

In another embodiment, the protease-containing feed additive composition can be used in a solid form. In one embodiment, the solid form is a pelleted form. In solid form, the feed additive composition may also contain one or more of: excipients such as microcrystalline cellulose, lactose, sodium citrate, calcium carbonate, dibasic calcium phosphate and glycine; disintegrants such as starch (preferably corn, potato or tapioca starch), sodium starch glycollate, croscarmellose sodium and certain complex silicates; granulation binders such as polyvinylpyrrolidone, hydroxypropylmethylcellulose (HPMC), hydroxypropylcellulose (HPC), sucrose, gelatin and acacia; lubricating agents such as magnesium stearate, stearic acid, glyceryl behenate and talc may be included.

Examples of nutritionally acceptable carriers for use in preparing the forms include, for example, water, salt solutions, alcohol, silicone, waxes, petroleum jelly, vegetable oils, polyethylene glycols, propylene glycol, liposomes, sugars, gelatin, lactose, amylose, magnesium stearate, talc, surfactants, silicic acid, viscous paraffin, perfume oil, fatty acid monoglycerides and diglycerides, petroethral fatty acid esters, hydroxymethyl-cellulose, polyvinylpyrrolidone, and the like.

In one embodiment, the protease-containing feed additive composition is formulated to a dry powder or granules as described in WO2007/044968 (referred to as TPT granules) or WO 1997/016076 or WO 1992/012645 (each of which is incorporated herein by reference).

In one embodiment, the protease-containing feed additive composition may be formulated to a granule feed composition comprising: an active agent comprising a protease and, optionally, one or more exogenous feed enzyme, one or more DFMs and at least one coating. In one embodiment, the active agent of the granule retains activity after processing. In one embodiment, the active agent of the granule retains an activity level after processing selected from the group consisting of: 50-60% activity, 60-70% activity, 70-80% activity, 80-85% activity, 85-90% activity, and 90-95% activity.

In another embodiment, the granule may contain one coating. The coating may comprise a moisture hydrating material that constitutes at least 55% w/w of the granule. In another embodiment, the granule may contain two coatings. The two coatings may be a moisture hydrating coating and a moisture barrier coating. In some embodiments, the moisture hydrating coating may be from 25% to 60% w/w of the granule and the moisture barrier coating may be from 2% to 15% w/w of the granule. The moisture hydrating coating may be selected from inorganic salts, sucrose, starch, and maltodextrin and the moisture barrier coating may be selected from polymers, gums, whey and starch.

In yet another embodiment, the granule may be produced using a feed pelleting process and the feed pretreatment process may be conducted between 70° C. and 95° C. for up to several minutes, such as between 85° C. and 95° C. In another embodiment, the granule may be produced using a steam-heated pelleting process that may be conducted between 85° C. and 95° C. for up to several minutes.

In one embodiment, the granule may have a moisture barrier coating selected from polymers and gums and the moisture hydrating material may be an inorganic salt. The moisture hydrating coating may be between 25% and 45% w/w of the granule and the moisture barrier coating may be between 2% and 20% w/w of the granule.

In one embodiment, the active agent (such as a protease) retains activity after conditions selected from one or more of: (a) a feed pelleting process; (b) a steam-heated feed pretreatment process; (c) storage; (d) storage as an ingredient in an unpelleted mixture; and (e) storage as an ingredient in a feed base mix or a feed premix comprising at least one compound selected from trace minerals, organic acids, reducing sugars, vitamins, choline chloride, and compounds which result in an acidic or a basic feed base mix or feed premix.

In some embodiments, the protease-containing feed additive composition may be diluted using a diluent, such as starch powder, lime stone, wheat bran, corn cob, or the like. In one embodiment, the DFM(s) and the enzymes may be in a liquid formulation suitable for consumption preferably such liquid consumption contains one or more of the following: a buffer, salt, sorbitol and/or glycerol. In another embodiment, the feed additive composition may be formulated by applying, e.g. spraying, the enzyme(s) onto a carrier substrate, such as ground wheat for example.

In one embodiment, the protease-containing feed additive composition may be formulated as a premix. By way of example only, the premix may comprise one or more feed components, such as one or more minerals and/or one or more vitamins.

In one embodiment, the protease-containing feed additive composition and optional exogenous feed enzymes and/or DFM(s) may be formulated with at least one physiologically acceptable carrier selected from at least one of maltodextrin, limestone (calcium carbonate), cyclodextrin, wheat or a wheat component, sucrose, starch, Na2SO4, Talc, PVA, sorbitol, benzoate, sorbiate, glycerol, sucrose, propylene glycol, 1,3-propane diol, glucose, parabens, sodium chloride, citrate, acetate, phosphate, calcium, metabisulfite, formate and mixtures thereof.

In another embodiment, the protease-containing feed additive composition can be delivered as an aqueous suspension and/or an elixir. The feed additive composition may be combined with various sweetening or flavoring agents, coloring matter or dyes, with emulsifying and/or suspending agents and with diluents such as water, propylene glycol and glycerin, and combinations thereof.

E. Feedstuff's

In another embodiment, provided herein are protease-containing feed additive compositions that may be used as a feed or in the preparation of a feed characterized by one or more of a soybean meal content having an acid detergent fiber (ADF) content greater than about 56 g/kg; a soybean meal content having a sulfur-containing amino acid content of less than about 13 g/kg; a majority of particles comprising less than 1 mm in size; and/or low buffer capacity. The feed may be in the form of a solution or as a solid depending on the use and/or the mode of application and/or the mode of administration. When used as a feed or in the preparation of a feed, such as functional feed, the feed additive composition may be used in conjunction with one or more of the following: a nutritionally acceptable carrier, a nutritionally acceptable diluent, a nutritionally acceptable excipient, a nutritionally acceptable adjuvant, a nutritionally active ingredient.

In one embodiment, the protease-containing feed additive composition disclosed herein is admixed with a feed component to form a feedstuff. In one embodiment, the feed may be a fodder, or a premix thereof, a compound feed, or a premix thereof. In one embodiment, the feed additive composition disclosed herein may be admixed with a compound feed, a compound feed component or a premix of a compound feed or to a fodder, a fodder component, or a premix of a fodder.

In one embodiment, fodder may be obtained from one or more of the plants selected from: alfalfa (lucerne), barley, birdsfoot trefoil, brassicas, Chau moellier, kale, rapeseed (canola), rutabaga (swede), turnip, clover, alsike clover, red clover, subterranean clover, white clover, grass, false oat grass, fescue, Bermuda grass, brome, heath grass, meadow grasses (from naturally mixed grassland swards, orchard grass, rye grass, Timothy-grass, corn (maize), millet, oats, sorghum, soybeans, trees (pollard tree shoots for tree-hay), wheat, and legumes.

Compound feeds can be complete feeds that provide all the daily required nutrients, concentrates that provide a part of the ration (protein, energy) or supplements that only provide additional micronutrients, such as minerals and vitamins. The main ingredients used in compound feed are the feed grains, which include corn, soybeans, sorghum, oats, and barley.

In one embodiment, a feedstuff as disclosed herein may comprise one or more feed materials selected from the group comprising cereals, such as small grains (e.g., wheat, barley, rye, oats and combinations thereof) and/or large grains such as maize or sorghum; by products from cereals, such as corn gluten meal, Distillers Dried Grain Solubles (DDGS), wheat bran, wheat middlings, wheat shorts, rice bran, rice hulls, oat hulls, palm kernel, and citrus pulp; protein obtained from sources such as soya, sunflower, peanut, lupin, peas, fava beans, cotton, canola, fish meal, dried plasma protein, meat and bone meal, potato protein, whey, copra, sesame; oils and fats obtained from vegetable and animal sources; and minerals and vitamins.

In yet another embodiment, a feedstuff may comprise at least one high fiber feed material and/or at least one by-product of the at least one high fiber feed material to provide a high fiber feedstuff. Examples of high fiber feed materials include: wheat, barley, rye, oats, by products from cereals, such as corn gluten meal, Distillers Dried Grain Solubles (DDGS), wheat bran, wheat middlings, wheat shorts, rice bran, rice hulls, oat hulls, palm kernel, and citrus pulp. Some protein sources may also be regarded as high fiber: protein obtained from sources such as sunflower, lupin, fava beans and cotton

In still another embodiment, the feed may be one or more of the following: a compound feed and premix, including pellets, nuts or (cattle) cake; a crop or crop residue: corn, soybeans, sorghum, oats, barley, corn stover, copra, straw, chaff, sugar beet waste; fish meal; freshly cut grass and other forage plants; meat and bone meal; molasses; oil cake and press cake; oligosaccharides; conserved forage plants: hay and silage; seaweed; seeds and grains, either whole or prepared by crushing, milling etc.; sprouted grains and legumes; yeast extract.

In one embodiment, the protease-containing feed additive composition of disclosed herein is admixed with the product (e.g. feedstuff). Alternatively, the feed additive composition may be included in the emulsion or raw ingredients of a feedstuff. In another embodiment, the feed additive composition is made available on or to the surface of a product to be affected/treated. In still another embodiment, the feed additive compositions disclosed herein may be applied, interspersed, coated and/or impregnated to a product (e.g. feedstuff or raw ingredients of a feedstuff) with a controlled amount of oxygen tolerant M. esldenii DFMs (and optionally one or more yeast strains and, further optionally, exogenous enzymes.

In yet another embodiment, the protease-containing feed additive composition and optional enzymes and/or DFMs may be used simultaneously (e.g. when they are in admixture together or even when they are delivered by different routes) or sequentially (e.g. they may be delivered by different routes).

### III. Methods

A. Methods for Improving the Bio-Efficacy of a Protease-Containing Feed Additive Composition

Further provided herein are methods for improving the bio-efficacy of a protease-containing feed additive composition. The method comprises adding a protease-containing feed additive composition to an animal feed or diet characterized by one or more of: a soybean meal having an acid detergent fiber (ADF) content greater than about 56 g/kg; a soybean meal having a sulfur-containing amino acid content of less than about 13 g/kg; a majority of particles comprising less than 1 mm in size; and/or low buffer capacity.

In some embodiments, the method can employ a soybean meal having an acid detergent fiber (ADF) content greater than about 56 g/kg (such as greater than about 57 g/kg, 58 g/kg, 59 g/kg, 60 g/kg, 61 g/kg, 62 g/kg, 63 g/kg, 64 g/kg, 65 g/kg, 66 g/kg or more). The ADF of soybean meal can be determined according to any means known in the art, including that described in Example 7. In additional embodiments, the method utilizes a soybean meal having a sulfur-containing amino acid content of less than about 13 g/kg, such as less than about 12 g/kg or less than about 11 g/kg. Sulfur-containing amino acid content can be determined according to any means known in the art, including that described in Example 8.

In some embodiments, the method can lead to improved bio-efficacy of the protease in the protease-containing feed additive composition as demonstrated by improved animal performance by greater than about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% compared to the bio-efficacy of a protease-containing feed or diet that does not contain a soybean meal having greater than about 56 g/kg ADF content and/or less than about 13 g/kg sulfur-containing amino acid content. In some embodiments, improved animal performance is determined by a parameter than can include, without limitation, increased weight gain and/or decreased feed conversion ratio.

In some embodiments of the method, the bio-efficacy of the protease in the protease-containing feed or diet is improved when the majority of the feed stuff (such as at least 50% or more, such as any of 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%) has a particle size of less than about 1 mm (such as less than any of about 950 μm, 900 μm, 850 μm, 800 μm, 750 μm, 700 μm, 650 μm, 600 μm, 550 μm, 500 μm, 450 μm, 400 μm, 350 μm, 300 μm, 250 μm, 200 μm, 150 μm, 100 μm or less, including all values falling in between these sizes). Particle size and percentage of particle size having a size of less than about 1 mm in a feedstuff can be determined by any means known in the art, including that described in Example 9.

In some embodiments, the method can lead to improved bio-efficacy of the protease in the protease-containing feed additive composition as demonstrated by improved animal performance by greater than about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% compared to the bio-efficacy of a protease-containing feed or diet that does not have a particle size of less than about 1 mm. In some embodiments, improved animal performance is determined by a parameter than can include, without limitation, increased weight gain and/or decreased feed conversion ratio.

The bio-efficacy of the protease in the protease-containing feed or diet can also be improved when the feed or diet is formulated to have a low buffer capacity. In some embodiments, a feed or diet has a low buffer capacity when the stabilized pH after moderate acid addition to a suspension of the animal feed less than about 4.2 (such as less than about 4.1, 4, 3.9, 3.8, 3.7, 3.6, or 3.5). In another embodiment, a feed or diet has a low buffer capacity when the stabilized pH after addition of 0.3 mol/kg HCl to a 10% suspension of the animal feed is less than 4.2 (such as less than about 4.1, 4, 3.9, 3.8, 3.7, 3.6, or 3.5). In still further embodiments, a feed or diet has a low buffer capacity when less than about 0.44 mol/kg (such as less thank about mol/kg, 0.42 mol/kg, 0.41 mol/kg, 0.4 mol/kg, 0.39 mol/kg, 0.38 mol/kg, 0.37 mol/kg, 0.36 mol/kg, or 0.35 mol/kg) HCl is added to reach a pH-value of 4.0. Buffer capacity can be determined by any means known in the art including the method described in Example 10.

In some embodiments, the method can lead to improved bio-efficacy of the protease in the protease-containing feed additive composition as demonstrated by improved animal performance by greater than about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% compared to the bio-efficacy of a protease-containing feed or diet that does not does not have low buffer capacity. In some embodiments, improved animal performance is determined by a parameter than can include, without limitation, increased weight gain and/or decreased feed conversion ratio.

B. Methods for Improving Animal Performance

Further provided herein are methods for increasing performance metrics of an animal. In another embodiment, the disclosure relates to methods of increasing performance metrics of a monogastric animal. In still another embodiment, the disclosure relates to methods of increasing performance metrics of poultry, including, but not limited to, broilers, layers, broiler breeders, turkey, duck, geese, pheasant, columbidae, or water fowl. In still another embodiment, the disclosure relates to methods of increasing performance metrics of swine, rabbits, calves, goat, or sheep.

Provided herein are methods comprising administering to an animal a composition comprising one or more of the feeds, feed additive compositions, or diets formulated to increase the bio-efficacy of a protease, such as any of the feeds, feed additive compositions, or diets disclosed herein that comprise a protease or a feed additive composition comprising a protease and one or more of a soybean meal having an acid detergent fiber (ADF) content greater than about 56 g/kg; and/or a soybean meal having a sulfur-containing amino acid content of less than about 13 g/kg; and/or (c) a majority of particles in the feed or diet comprise less than 1 mm in size; and/or (d) the diet has low buffer capacity. In still another embodiment, the disclosure relates to a method comprising administering to an animal an effective amount of a feed, feed additive composition, or diet (such as any of the feeds, feed additive compositions, or diets disclosed herein) formulated to increase the bio-efficacy of a protease to increase performance of the animal. This effective amount can be administered to the animal in one or more doses.

In another embodiment, the disclosure relates to a method comprising administering to an animal (such as a monogastric animal, for example, poultry or swine) an effective amount of a protease-containing feed, feed additive composition, or diet (such as any of the feeds, feed additive compositions, or diets disclosed herein) formulated to increase the bio-efficacy of a protease to increase average daily feed intake. In some embodiments, the average daily feed intake increases by any of about 10%, 15%, 20%, 25%, 30%, 35%, 40%, 45%, 50%, 55%, 60%, 65%, 70%, 75%, 80%, 85%, 90%, 95%, 100%, 105%, or 110%, inclusive of all values falling in between these percentages, relative to animals who are not administered a feed, feed additive composition, or diet formulated to increase the bio-efficacy of a protease. In another embodiment, the composition further includes one or more exogenous enzymes, such as an amylase, phytase, xylanase, and/or glucoamylase.

In another embodiment, the disclosure relates to a method comprising administering to an animal (such as a monogastric animal, for example, poultry or swine) an effective amount of a protease-containing feed, feed additive composition, or diet (such as any of the feeds, feed additive compositions, or diets disclosed herein) formulated to increase the bio-efficacy of a protease to increase average daily weight gain. In some embodiments, the average daily weight gain increases by any of about 10%, 15%, 20%, 25%, 30%, 35%, 40%, 45%, 50%, 55%, 60%, 65%, 70%, 75%, 80%, 85%, 90%, 95%, 100%, 105%, or 110%, inclusive of all values falling in between these percentages, relative to animals who are not administered a feed, feed additive composition, or diet formulated to increase the bio-efficacy of a protease. In another embodiment, the composition further includes one or more exogenous enzymes, such as an amylase, phytase, xylanase, and/or glucoamylase.

In another embodiment, the disclosure relates to a method comprising administering to an animal (such as a monogastric animal, for example, poultry or swine) an effective amount of a protease-containing feed, feed additive composition, or diet (such as any of the feeds, feed additive compositions, or diets disclosed herein) formulated to increase the bio-efficacy of a protease to increase total weight gain. In some embodiments, total weight gain increases by any of about 10%, 15%, 20%, 25%, 30%, 35%, 40%, 45%, 50%, 55%, 60%, 65%, 70%, 75%, 80%, 85%, 90%, 95%, 100%, 105%, or 110%, inclusive of all values falling in between these percentages, relative to animals who are not administered a feed, feed additive composition, or diet formulated to increase the bio-efficacy of a protease. In another embodiment, the composition further includes one or more exogenous enzymes, such as a protease, amylase, phytase, xylanase, and/or glucoamylase.

In another embodiment, the disclosure relates to a method comprising administering to an animal (such as a monogastric animal, for example, poultry or swine) an effective amount of a protease-containing feed, feed additive composition, or diet (such as any of the feeds, feed additive compositions, or diets disclosed herein) formulated to increase the bio-efficacy of a protease to decrease feed conversion ratio (FCR). In some embodiments, FCR decreases by any of about 10%, 15%, 20%, 25%, 30%, 35%, 40%, 45%, 50%, 55%, 60%, 65%, 70%, 75%, 80%, 85%, 90%, 95%, or 100%, inclusive of all values falling in between these percentages, relative to animals who are not administered a feed, feed additive composition, or diet formulated to increase the bio-efficacy of a protease. In another embodiment, the composition further includes one or more exogenous enzymes, such as an amylase, phytase, xylanase, and/or glucoamylase.

The invention can be further understood by reference to the following examples, which are provided by way of illustration and are not meant to be limiting.

### EXAMPLES

### Example 1: In Vivo Broiler Trial 1

An experiment was conducted to evaluate the bio-efficacy of protease-containing feed additives on growth performance of broiler chickens. The experimental procedure complied with welfare guidelines and was approved by the Animal Care and Use Committee relevant for the country.

Male broiler (Cobb 500) chicks were obtained as day-olds from a commercial hatchery. The chicks were divided into groups of 21 birds and allocated to floor pens with uniform pen weight. The two dietary treatments were randomly assigned to 9 groups each. The pens were housed in environmentally controlled rooms with temperatures adapted to the age of the birds, and the birds were allowed free access to the diets and water.

A two-phase feeding programme (starter and finisher) was used (Table 1a). The starter and finisher diets were offered from day 1 to 21 and day 21 to 42, respectively. The diets were formulated to contain respectively 2786 kcal/kg of metabolic energy (ME) and 19.7% crude protein and 2870 kcal/kg ME and 17.2% crude protein. For each diet, the metabolic energy for broilers and crude protein content were calculated using ingredient specific values obtained from the CVB Feed Table 2018 (Federatie Nederlandse Diervoederketen (FND), world wide web.cvbdiervoeding.nl/be stand/10501/cvb-feed-table-2018-edition-2.pdf.ashx).

TABLE 1a
Composition of the basal diets used

| | Starter | Finisher |
|---|---|---|
| Corn | 61.1 | 66.1 |
| Soybean meal 46% | 28.4 | 19.4 |
| Full fat soya (toasted) | 1.94 | 5.00 |
| Wheat bran | 3.50 | 5.20 |
| Soybean oil | 1.00 | 1.00 |
| L-Lysine | 0.20 | 0.20 |
| DL-Methionine | 0.27 | 0.21 |
| L-Theonine | 0.03 | 0.03 |
| Calcium hydrogen phosphate | 0.96 | 0.45 |
| Calcium carbonate | 1.35 | 1.18 |
| Salt | 0.40 | 0.40 |
| Premix | 0.30 | 0.30 |
| Enzyme product* | 0.03 | 0.03 |
| Filler space | 0.50 | 0.50 |

*Contained 825 FTU/kg of Axtra ® PHY

For each basal diet, two experimental diets were made, an unsupplemented diet to constitute a control and a diet supplemented with 4400 U/kg of subtilisin (protease) (EC 3.4.21.62) from Bacillus subtilis included as part of the enzyme product.

Body weight (BW) measured as pen weight and feed intake (FI) measured per pen were recorded at day 21 and 42. Mortality and the weight of dead birds were recorded daily. Body weight gain (BWG) was calculated as the difference between the BW divided by the number of birds at separate days. Feed conversion ratio (FCR) was calculated by dividing the total feed intake by weight gain of live plus dead birds.

In the finisher phase, the diets used for trial 1 was characterized with regards to particle size and buffer capacity. The diet had a small fraction of particles with a size above 1 mm (<40%). The pH-value were measured to be above 4.2 after addition of 0.3 mol/kg of HCl and a total of more than 0.44 mol/kg of HCl was required to reach a pH-value of 4.0 following the procedure in Example 10.

The results of the growth performance are summarized in Table 1b for the whole experimental period from day 1 to 42. The supplement of the protease was not effective in improving the body weight gain or the feed conversion ratio compared to the control diet.

TABLE 1b
Calculated growth performance data.

| Experimental | BWG | Improvement | FCR | Improvement |
|---|---|---|---|---|
| diet | (d 1-42) (g) | in BWG (%) | (d 1-42) | in FCR (%) |
| Control | 2484 | | 1.82 | |
| Protease | 2493 | 0.4 | 1.81 | 0.5 |
| treatment | | | | |

### Example 2: In Vivo Broiler Trial 2

An experiment was conducted to evaluate the bio-efficacy of protease containing feed additives on growth performance of broiler chickens. The experimental procedure complied with welfare guidelines and was approved by the Animal Care and Use Committee relevant for the country.

Male broiler (Ross 308) chicks were obtained as day-olds from a commercial hatchery. The chicks were divided into groups of 10 birds and allocated to floor pens with uniform pen weight. The two dietary treatments were randomly assigned to 9 groups each. The pens were housed in environmentally controlled rooms with temperatures adapted to the age of the birds, and the birds were allowed free access to the diets and water.

A two-phase feeding programme (starter and finisher) was used (Table 2a). The starter and finisher diets were offered from day 1 to 21 and day 21 to 42, respectively. The diets were formulated to contain respectively 2786 kcal/kg of metabolic energy (ME) and 19.7% crude protein and 2870 kcal/kg ME and 17.2% crude protein. For each diet, the metabolic energy for broilers and crude protein content were calculated using ingredient specific values obtained from the CVB Feed Table 2018 (Federatie Nederlandse Diervoederketen (FND), world wide web.cvbdiervoeding.nl/be stand/10501/cvb-feed-table-2018-edition-2.pdf.ashx).

TABLE 2a
Composition of the basal diets used.

| | Starter | Finisher |
|---|---|---|
| Corn | 61.1 | 66.1 |
| Soybean meal 46% | 28.4 | 19.4 |
| Full fat soya (toasted) | 1.94 | 5.00 |
| Wheat bran | 3.50 | 5.20 |
| Soybean oil | 1.00 | 1.00 |
| L-Lysine | 0.20 | 0.23 |
| DL-Methionine | 0.27 | 0.21 |
| L-Theonine | 0.03 | 0.03 |
| Calcium hydrogen phosphate | 0.96 | 0.45 |
| Calcium carbonate | 1.35 | 1.18 |
| Salt | 0.40 | 0.40 |
| Premix | 0.30 | 0.30 |
| Enzyme product* | 0.01 | 0.01 |
| Filler space | 0.50 | 0.50 |

*Contained 825 FTU/kg of Axtra ® PHY

For each basal diet, two experimental diets were made, an unsupplemented diet to constitute a control and a diet supplemented with 4000 U/kg of subtilisin (protease) (EC 3.4.21.62) from Bacillus subtilis included as part of the enzyme product.

Body weight (BW) measured as pen weight and feed intake (FI) measured per pen were recorded at day 21 and 42. Mortality and the weight of dead birds were recorded daily. Body weight gain (BWG) was calculated as the difference between BW divided by the number of birds at separate days. Feed conversion ratio (FCR) was calculated by dividing the total feed intake by weight gain of live plus dead birds.

In the finisher phase, the diets used for trial 1 was characterized with regards to particle size and buffer capacity. The diet had a small fraction of particles with a size above 1 mm (<40%). The pH-value were measured to be above 4.2 after addition of 0.3 mol/kg of HCl and a total of more than 0.44 mol/kg of HCl was required to reach a pH-value of 4.0 following the procedure in Example 10.

The results of the growth performance are summarized in Table 2b for the whole experimental period from day 1 to 42. The supplement of the protease resulted in an improvement in both the body weight gain and the feed conversion ratio by >3% compared to the control diet.

TABLE 2b
Calculated growth performance data.

| Experimental | BWG | Improvement | FCR | Improvement |
|---|---|---|---|---|
| diet | (d 1-42) (g) | in BWG (%) | (d 1-42) | in FCR (%) |
| Control | 3419 | | 1.56 | |
| Protease | 3546 | 3.7 | 1.51 | 3.1 |
| treatment | | | | |

### Example 3: In Vivo Broiler Trial 3

An experiment was conducted to evaluate the bio-efficacy of protease containing feed additives on growth performance of broiler chickens. The experimental procedure complied with welfare guidelines and was approved by the Animal Care and Use Committee relevant for the country.

Male broiler (Cobb 500) chicks were obtained as day-olds from a commercial hatchery. The chicks were divided into groups of 16 birds and allocated to floor pens with uniform pen weight. The two dietary treatments were randomly assigned to 10 groups each. The pens were housed in environmentally controlled rooms with temperatures adapted to the age of the birds, and the birds were allowed free access to the diets and water.

A three-phase feeding programme (starter, grower and finisher) was used (Table 3a). The starter, grower and finisher diets were offered from d 1 to 10, 10-25 and 25 to 42, respectively. The diets were formulated to contain 2812 kcal/kg of metabolic energy (ME) and crude protein, 2907 kcal/kg ME and 18.2% crude protein and 2958 kcal/kg ME and 16.4% crude protein, respectively for the three phases. For each diet, the metabolic energy for broilers and crude protein content were calculated using ingredient specific values obtained from the CVB Feed Table 2018 (Federatie Nederlandse Diervoederketen (FND), world wide web.cvbdiervoeding.nl/be stand/10501/cvb-feed-table-2018-edition-2.pdf.ashx).

TABLE 3a
Composition of the basal diets used.

| | Starter | Grower | Finisher |
|---|---|---|---|
| Corn | 65.1 | 70.6 | 74.9 |
| Soybean meal 48% | 30.1 | 25.0 | 20.9 |
| Soybean oil | 0.40 | 0.74 | 0.78 |
| L-Lysine | 0.34 | 0.30 | 0.27 |
| DL-Methionine | 0.34 | 0.28 | 0.24 |
| L-Theonine | 0.10 | 0.08 | 0.06 |
| Calcium hydrogen phosphate | 1.24 | 0.98 | 0.84 |
| Calcium carbonate | 1.28 | 1.07 | 1.05 |
| Salt | 0.52 | 0.35 | 0.35 |
| Premix | 0.50 | 0.50 | 0.50 |
| Enzyme product* | 0.06 | 0.06 | 0.06 |

*Contained 825 FTU/kg of Axtra ® PHY

For each basal diet, two experimental diets were made, an unsupplemented diet to constitute a control and a diet supplemented with 3000 U/kg of subtilisin (protease) (EC 3.4.21.62) from Bacillus subtilis included as part of the enzyme product.

Body weight (BW) measured as pen weight and feed intake (FI) measured per pen were recorded at day 10, 25 and 42. Mortality and the weight of dead birds were recorded daily. Body weight gain (BWG) was calculated as the difference between BW divided by the number of birds at separate days. Feed conversion ratio (FCR) was calculated by dividing the total feed intake by weight gain of live plus dead birds.

The soybean meal sample was characterized with regards to the content of acid detergent fiber (ADF) and Sulphur-containing amino acids. The measured ADF content was lower than 56 g/kg and the Sulphur-containing amino acids content was higher than 13 g/kg.

In the finisher phase, the diets used for trial 3 was characterized with regards to particle size and buffer capacity. Particles with a size above 1 mm constituted more than 40% of the total sample weight. The pH-value were measured to be above 4.2 after addition of 0.3 mol/kg of HCl and a low amount of HCl (<0.44 mol/kg) needed to be added to reach a pH-value of 4.0 following the procedure Example 10.

The results of the growth performance are summarized in Table 3b for the whole experimental period from day 1 to 42. The supplement of the protease was not effective in improving the body weight gain or the feed conversion ratio compared to the control diet

TABLE 3b
Calculated growth performance data

| Experimental | BWG | Improvement | FCR | Improvement |
|---|---|---|---|---|
| diet | (d 1-42) (g) | in BWG (%) | (d 1-42) | in FCR (%) |
| Control | 2385 | | 1.70 | |
| Protease | 2277 | −4.5 | 1.70 | 0.1 |
| treatment | | | | |

### Example 4: In Vivo Broiler Trial 4

An experiment was conducted to evaluate the bio-efficacy of protease containing feed additives on growth performance of broiler chickens. The experimental procedure complied with welfare guidelines and was approved by the Animal Care and Use Committee relevant for the country.

Male broiler (Cobb 500) chicks were obtained as day-olds from a commercial hatchery. The chicks were divided into groups of 20 birds and allocated to floor pens with uniform pen weight. The two dietary treatments were randomly assigned to 10 groups each. The pens were housed in environmentally controlled rooms with temperatures adapted to the age of the birds, and the birds were allowed free access to the diets and water.

A two-phase feeding programme (starter and finisher) was used (Table 4a). The starter and finisher diets were offered from day 1 to 21 and day 21 to 42, respectively. The diets were formulated to contain respectively 2839 kcal/kg of metabolic energy (ME) and 21.4% crude protein and 2992 kcal/kg ME and 18.0% crude protein. For each diet, the metabolic energy for broilers and crude protein content were calculated using ingredient specific values obtained from the CVB Feed Table 2018 (Federatie Nederlandse Diervoederketen (FND), world wide web.cybdiervoeding.nl/bestand/10501/cvb-feed-table-2018-edition-2.pdf.ashx). Values for AMEn broiler obtained from INRA-CIRAD-AFZ feed tables were used for ingredients with no ingredient specific value for metabolic energy for broilers listed in the CVB Feed Table 2018.

TABLE 4a
Composition of the basal diets used.

| | Starter | Finisher |
|---|---|---|
| Corn | 59.5 | 66.9 |
| Soybean meal 48% | 30.7 | 23.0 |
| Corn DDGS (Low oil) | 5.00 | 5.00 |
| Soybean oil | 1.33 | 2.33 |
| L-Lysine | 0.27 | 0.20 |
| DL-Methionine | 0.25 | 0.19 |
| L-Theonine | 0.09 | 0.07 |
| Calcium phosphate | 0.76 | 0.50 |
| Calcium carbonate | 1.30 | 1.13 |
| Salt | 0.30 | 0.32 |
| Sodium hydrogen carbonate | 0.19 | 0.16 |
| Premix | 0.18 | 0.18 |
| Salinomycin | 0.05 | 0.05 |
| Enzyme product* | 0.02 | 0.02 |

*Contained 750 FTU/kg of Axtra ® PHY

For each basal diet, two experimental diets were made, an unsupplemented diet to constitute a control and a diet supplemented with 4000 U/kg of subtilisin (protease) (EC 3.4.21.62) from Bacillus subtilis included as part of the enzyme product.

Body weight (BW) measured as pen weight and feed intake (FI) measured per pen were recorded at day 21 and 42. Mortality and the weight of dead birds were recorded daily. Body weight gain (BWG) was calculated as the difference between BW divided by the number of birds at separate days. Feed conversion ratio (FCR) was calculated by dividing the total feed intake by weight gain of live plus dead birds.

The soybean meal sample was characterized with regards to the content of acid detergent fiber (ADF) and Sulphur-containing amino acids. The soybean meal sample had a relatively high ADF content (>56 g/kg) and a low content (<13 g/kg) of the Sulphur-containing amino acids.

In the finisher phase, the diets used for trial 4 was characterized with regards to particle size and buffer capacity. The diet had a small fraction of particles with a size above 1 mm (<40% of the total sample weight). The pH-value were measured to be above 4.2 after addition of 0.3 mol/kg of HCl, however a low amount of HCl (<0.44 mol/kg) needed to be added to reach a pH-value of 4.0 following the procedure in Example 10.

The results of the growth performance are summarized in Table 4b for the whole experimental period from day 1 to 42. The supplement of the protease resulted in an improvement in body weight gain by >3% compared to the control diet with no change in the feed conversion ratio.

TABLE 4b
Calculated growth performance data.

| Experimental | BWG | Improvement | FCR | Improvement |
|---|---|---|---|---|
| diet | (d 1-42) (g) | in BWG (%) | (d 1-42) | in FCR (%) |
| Control | 2646 | | 1.79 | |
| Protease | 2726 | 3.0 | 1.78 | 0.5 |
| treatment | | | | |

### Example 5: In Vivo Broiler Trial 5

An experiment was conducted to evaluate the bio-efficacy of protease containing feed additives on growth performance of broiler chickens. The experimental procedure complied with welfare guidelines and was approved by the Animal Care and Use Committee relevant for the country.

Male broiler (Ross 308) chicks were obtained as day-olds from a commercial hatchery. The chicks were divided into groups of 24 birds and allocated to floor pens with uniform pen weight. The two dietary treatments were randomly assigned to 8 groups each. The pens were housed in environmentally controlled rooms with temperatures adapted to the age of the birds, and the birds were allowed free access to the diets and water.

A three-phase feeding programme (starter, grower and finisher) was used (Table 5a). The starter, grower and finisher diets were offered from d 1 to 10, 10-21 and 21 to 42, respectively. The diets were formulated to contain 2837 kcal/kg of metabolic energy (ME) and 22.1% crude protein, 2943 kcal/kg ME and 20.6% crude protein and 2999 kcal/kg ME and 18.4% crude protein, respectively for the three phases. For each diet, the metabolic energy for broilers and crude protein content were calculated using ingredient specific values obtained from the CVB Feed Table 2018 (Federatie Nederlandse Diervoederketen (FND), world wide web.cvbdiervoeding.nl/be stand/10501/cvb-feed-table-2018-edition-2.pdf.ashx).

TABLE 5a
Composition of the basal diets used

| | Starter | Grower | Finisher |
|---|---|---|---|
| Corn | 55.8 | 42.6 | 41.3 |
| Soybean meal 47% | 28.8 | 23.4 | 17.0 |
| Rapeseed meal | 4.00 | 2.50 | 2.50 |
| Full fat soya (toasted) | 6.00 | 9.00 | 9.00 |
| Wheat | — | 17.0 | 25.0 |
| Soybean oil | 1.83 | 2.64 | 2.60 |
| L-Lysine | 0.27 | 0.10 | 0.11 |
| DL-Methionine | 0.31 | 0.20 | 0.15 |
| L-Theonine | 0.11 | — | — |
| Calcium phosphate | 1.01 | 0.74 | 0.49 |
| Calcium carbonate | 1.02 | 1.02 | 1.07 |
| Sodium hydrogen carbonate | 0.15 | 0.10 | 0.10 |
| Salt | 0.30 | 0.31 | 0.25 |
| Premix | 0.40 | 0.40 | 0.40 |
| Enzyme product* | 0.025 | 0.025 | 0.025 |

*Contained 750 FTU/kg of Axtra ® PHY

For each basal diet, two experimental diets were made, an unsupplemented diet to constitute a control and a diet supplemented with 4000 U/kg of subtilisin (protease) (EC 3.4.21.62) from Bacillus subtilis included as part of the enzyme product.

Body weight (BW) measured as pen weight and feed intake (FI) measured per pen were recorded at day 10, 21 and 42. Mortality and the weight of dead birds were recorded daily. Body weight gain (BWG) was calculated as the difference between BW divided by the number of birds at separate days. Feed conversion ratio (FCR) was calculated by dividing the total feed intake by weight gain of live plus dead birds.

The soybean meal sample was characterized with regards to the content of acid detergent fiber (ADF) and Sulphur-containing amino acids. The soybean meal sample had a relatively high ADF content (>56 g/kg) and a low content (<13 g/kg) of the Sulphur-containing amino acids.

In the finisher phase, the diets used for trial 5 was characterized with regards to particle size and buffer capacity. The diet had a small fraction of particles with a size above 1 mm (<40% of the total sample weight). The pH-value were measured to be low (<4.2) after addition of 0.3 mol/kg of HCl and a low amount of HCl (<0.44 mol/kg) needed to be added to reach a pH-value of 4.0 following the procedure in Example 10.

The results of the growth performance are summarized in Table 5b for the whole experimental period from day 1 to 42. The supplement of the protease resulted in respective improvements in body weight gain by 2.0% and of the feed conversion ratio by >3% compared to the control diet.

TABLE 5b
Calculated growth performance data.

| Experimental | BWG | Improvement | FCR | Improvement |
|---|---|---|---|---|
| diet | (d 1-42) (g) | in BWG (%) | (d 1-42) | in FCR (%) |
| Control | 2492 | | 1.68 | |
| Protease | 2541 | 2.0 | 1.63 | 3.1 |
| treatment | | | | |

### Example 6: In Vivo Broiler Trial 6

An experiment was conducted to evaluate the bio-efficacy of protease containing feed additives on growth performance of broiler chickens. The experimental procedure complied with welfare guidelines and was approved by the Animal Care and Use Committee relevant for the country.

Male broiler (Ross 308) chicks were obtained as day-olds from a commercial hatchery. The chicks were divided into groups of 23 birds and allocated to floor pens with uniform pen weight. The two dietary treatments were randomly assigned to 8 groups each. The pens were housed in environmentally controlled rooms with temperatures adapted to the age of the birds, and the birds were allowed free access to the diets and water.

A two-phase feeding programme (starter and finisher) was used (Table 6a). The starter and finisher diets were offered from day 1 to 21 and day 21 to 42, respectively. The diets were formulated to contain respectively 2786 kcal/kg of metabolic energy (ME) and 19.7% crude protein and 2870 kcal/kg ME and 17.2% crude protein. For each diet, the metabolic energy for broilers and crude protein content were calculated using ingredient specific values obtained from the CVB Feed Table 2018 (Federatie Nederlandse Diervoederketen (FND), world wide web.cvbdiervoeding.nl/be stand/10501/cvb-feed-table-2018-edition-2.pdf.ashx).

TABLE 6a
Composition of the basal diets used.

| | Starter | Finisher |
|---|---|---|
| Corn | 61.1 | 66.1 |
| Soybean meal 46% | 28.4 | 19.4 |
| Full fat soya (toasted) | 1.94 | 5.00 |
| Wheat bran | 3.50 | 5.20 |
| Soybean oil | 1.00 | 1.0 |
| L-Lysine | 0.20 | 0.23 |
| DL-Methionine | 0.27 | 0.21 |
| L-Theonine | 0.03 | 0.03 |
| Calcium hydrogen phosphate | 0.96 | 0.45 |
| Calcium carbonate | 1.35 | 1.18 |
| Salt | 0.40 | 0.40 |
| Premix | 0.30 | 0.30 |
| Enzyme product* | 0.01 | 0.01 |
| Filler space | 0.50 | 0.50 |

*Contained 750 FTU/kg of Axtra ® PHY

For each basal diet, two experimental diets were made, an unsupplemented diet to constitute a control and a diet supplemented with 4000 U/kg of subtilisin (protease) (EC 3.4.21.62) from Bacillus subtilis included as part of the enzyme product.

Body weight (BW) measured as pen weight and feed intake (FI) measured per pen were recorded at day 21 and 42. Mortality and the weight of dead birds were recorded daily. Body weight gain (BWG) was calculated as the difference between BW divided by the number of birds at separate days. Feed conversion ratio (FCR) was calculated by dividing the total feed intake by weight gain of live plus dead birds.

The soybean meal sample was characterized with regards to the content of acid detergent fiber (ADF) and Sulphur-containing amino acids. The soybean meal sample had a relatively high ADF content (>56 g/kg) and a low content (<13 g/kg) of the Sulphur-containing amino acids.

In the finisher phase, the diets used for trial 6 was characterized with regards to particle size and buffer capacity. The diet had a small fraction of particles with a size above 1 mm (<40% of the total sample weight). The pH-value were measured to be low (<4.2) after addition of 0.3 mol/kg of HCl and a low amount of HCl (<0.44 mol/kg) needed to be added to reach a pH-value of 4.0 following the procedure in Example 10.

The results of the growth performance are summarized in Table 6b for the whole experimental period from day 1 to 42. The supplement of the protease resulted in an improvement in body weight gain by >3% compared to the control diet with no change in the feed conversion ratio

TABLE 6b
Calculated growth performance data.

| Experimental | BWG | Improvement | FCR | Improvement |
|---|---|---|---|---|
| diet | (d 1-42) (g) | in BWG (%) | (d 1-42) | in FCR (%) |
| Control | 2246 | | 1.75 | |
| Protease | 2363 | 5.2 | 1.74 | 0.4 |
| treatment | | | | |

### Example 7: Dietary Acid Detergent Fiber Content

For the soybean meal used in the feed formulations, the acid detergent fiber (ADF) content was measured by using the method: ISO 13906 Animal feeding stuffs—Determination of acid detergent fibre (ADF) and acid detergent lignin (ADL) contents. The values measured for the soybean meal used for trial 3-6 are shown in Table 7.

TABLE 7

ADF content of soybean meal used in trials 3-6

| | Trial 3 | Trial 4 | Trial 5 | Trial 6 |
|---|---|---|---|---|
| ADF (g/kg) | 54.5 | 57.4 | 58.5 | 65.1 |

The soybean meal samples used for trial 4-6 had a relatively high ADF content (>56 g/kg), in contrast to the soybean sample used for trial 3, which had an ADF content lower than 56 g/kg.

### Example 8: Cystine, Cysteine and Methionine Quantification

For the soybean meal used in the feed formulations, the content of the Sulphur-containing amino acids was measured using the method: ISO 13903 Animal feeding stuffs—Determination of amino acids content.

The values measured for the soybean meal used for trial 3-6 is shown in Table 8. The result is given as the sum of cystine, cysteine and methionine.

TABLE 8
Cystine, cysteine and methionine content
of soybean meal used in trials 3-6

| | Trial 3 | Trial 4 | Trial 5 | Trial 6 |
|---|---|---|---|---|
| Total amount of cystine, | 14.4 | 12.1 | 11.6 | 12.3 |
| cysteine and methionine (g/kg) | | | | |

The soybean meal samples used for trial 4-6 had a low content of Sulphur-containing amino acids (<13 g/kg), in contrast to the soybean meal sample used for trial 3, which had a Sulphur-containing amino acids content higher than 13 g/kg.

### Example 9: Fractionation of the Diet According to Particle Size

The fraction of the sample with particle size greater than 1 mm was determined by recording the precise weight of 50 ml solid sample before manually sieving of the sample through a 1 mm grid. The precise weight of the retained particles was recorded, and the fraction was calculated as the ratio between the weight of the retained particles and the full sample.

The values measured for diets utilized in the finisher phase until day 42 for trial 1-6 are shown in Table 9.

TABLE 9
Particle size for trials 1-6

| | Trial | Trial | Trial | Trial | Trial | Trial |
|---|---|---|---|---|---|---|
| | 1 | 2 | 3 | 4 | 5 | 6 |
| Fraction with particles | 24 | 42 | 47 | 37 | 27 | 38 |
| size >1 mm (%) | | | | | | |

The diets used for trial 1 and 4-6 had a small fraction of particles with a size above 1 mm (<40%) in contrast to the diets used for trial 2 and 3, for which particles with a size above 1 mm constituted more than 40% of the total weight.

### Example 10: Buffer Capacity Measurements of Diets

A 5 g sample of the diet (the feed stuff) was mixed with 50 ml deionized water and stirred for 30 minutes. 1.5 ml of 1 M HCl was added. After additional 30 minutes of stirring the stabilized pH-value of the suspension was recorded.

Additional 1 M HCl was added using a titrator (775 Dosimat, Metrohm) until a pH of 4.0 was reached and remained at pH 4 for 30 minutes of stirring. The total volume (in ml) of 1 M HCl was recorded and converted to mol HCl added per kg feed stuff.

The values measured for the diets utilized in the finisher phase until day 42 for trial 1-6 are shown in Table 10.

TABLE 10
Buffer capacity measurements of diets for trials 1-6.

| | Trial | Trial | Trial | Trial | Trial | Trial |
|---|---|---|---|---|---|---|
| | 1 | 2 | 3 | 4 | 5 | 6 |
| Stabilized pH with | 4.6 | 3.9 | 4.3 | 4.5 | 4.2 | 3.9 |
| addition of 0.3 mol/kg | | | | | | |
| HCl | | | | | | |
| Amount of HCl to obtain | 0.46 | 0.37 | 0.38 | 0.43 | 0.41 | 0.40 |
| pH 4.0 (mol/kg) | | | | | | |

For the total diet used for trial 1, 3 and 4, pH values above 4.2 were measured applying the same amount of acid (1.5 ml 1 M HCl) to the samples, whereas lower values (<4.2) were measured for the total diets used for trial 2, 5 and 6.

A low amount of HCl (<0.44 mol/kg) was needed to be added to trial 2-6 to reach a pH-value of 4.0, whereas more than 0.44 mol/kg was required for the diet used for trial 1.

SEQUENCES

AQSVPYGVSQ IKAPALHSQG YTGSNVKVAV IDSGIDSSHP
DLKVAGGASM VPSETNPFQD NNSHGTHVAG
TVAALNNSIG VLGVAPSASL YAVKVLGADG SGQYSWIING
IEWAIANNMD VINMSLGGPS GSAALKAAVD
KAVASGVVVV AAAGNEGTSG SSSTVGYPGK YPSVIAVGAV
DSSNQRASFS SVGPELDVMA PGVSIQSTLP
GNKYGALNGT SMASPHVAGA AALILSKHPN WTNTQVRSSL
ENTTTKLGDS FYYGKGLINV QAAAQ (SEQ ID NO: 1)

We claim:

1. A method for improving the bio-efficacy of a protease-containing feed or diet, comprising adding a protease-containing feed additive composition to an animal feed characterized by one or more of:
(a) a soybean meal having an acid detergent fiber (ADF) content greater than about 56 g/kg;
(b) a soybean meal having a sulfur-containing amino acid content of less than about 13 g/kg;
(c) a majority of particles comprising less than 1 mm in size; and/or
(d) low buffer capacity.

2. The method of claim 1, wherein the protease is a subtilisin, a bacillolysin, an alkaline serine protease, a keratinase or a Nocardiopsis protease.

3. The method of claim 1, wherein the protease is 80% identical to the protease of SEQ ID NO:1.

4. The method of any one of claims 1-3, wherein the ADF content of the soybean meal is greater than about 58 g/kg, 60 g/kg, 62 g/kg, 64 g/kg, or 66 g/kg.

5. The method of any one of claims 1-4, wherein the sulfur-containing amino acid content of the soybean meal is less than about 12 g/kg or 11 g/kg.

6. The method of any one of claims 1-5, wherein at least about 60% of the particles in the animal feed comprise less than 1 mm in size.

7. The method of any one of claims 1-6, wherein the stabilized pH after addition of 0.3 mol/kg HCl to a 10% suspension of the animal feed is less than 4.2.

8. The method of any one of claims 1-6, wherein less than 0.44 mol/kg HCl is added to a 10% suspension of the animal feed to reach a pH-value of 4.0.

9. The method of any one of claims 1-8, wherein the feed additive composition further comprises one or more additional enzymes selected from the group consisting of a xylanase, amylase, phytase, glucoamylase, pectinase, mannanase, and β-glucanase.

10. The method of any one of claims 1-9, wherein the feed additive composition further comprises one or more direct fed microbials (DFMs) or fermentates thereof.

11. The method of claim 10, wherein the DFM comprises a bacterium from one or more of the following genera: Lactobacillus, Lactococcus, Streptococcus, Bacillus, Pediococcus, Enterococcus, Leuconostoc, Carnobacterium, Propionibacterium, Bifidobacterium, Clostridium or Megasphaera and combinations thereof.

12. The method of claim 10 or claim 11, wherein the DFM comprises a bacterium from one or more of the following species: Bacillus subtilis, Bacillus licheniformis, Bacillus amyloliquefaciens, Enterococcus sp, Pediococcus sp, Lactobacillus sp, Bifidobacterium sp, Lactobacillus acidophilus, Pediococsus acidilactici, Lactococcus lactis, Bifidobacterium bifidum, Propionibacterium thoenii, Lactobacillus farciminus, Lactobacillus rhamnosus, Clostridium butyricum, Bifidobacterium animalis ssp. animalis, Lactobacillus reuteri, Bacillus cereus, Lactobacillus salivariu, Megasphaera elsdenii, Propionibacteria sp, or combinations thereof.

13. The method of any one of claims 1-12, wherein the feed additive composition further comprises one or more essential oils.

14. The method of claim 13, wherein the essential oil is thymol and/or cinnamaldehyde.

15. A method for formulating a diet for an animal, the method comprising combining a protease with one or more of:
(a) a soybean meal having an acid detergent fiber (ADF) content greater than about 56 g/kg; and/or
(b) a soybean meal having a sulfur-containing amino acid content of less than about 13 g/kg;
wherein, optionally,
(c) a majority of particles in the diet comprise less than 1 mm in size; and/or
(d) the diet has low buffer capacity.

16. The method of claim 15, wherein the protease is a subtilisin, a bacillolysin, an alkaline serine protease, a keratinase or a Nocardiopsis protease.

17. The method of claim 15, wherein the protease is 80% identical to the protease of SEQ ID NO:1.

18. The method of any one of claims 15-17 wherein the ADF content of the soybean meal is greater than about 58 g/kg, 60 g/kg, 62 g/kg, 64 g/kg, or 66 g/k.

19. The method of any one of claims 15-18, wherein the sulfur-containing amino acid content of the soybean meal is less than about 12 g/kg or 11 g/kg.

20. The method of any one of claims 15-19, wherein at least about 60% of the particles in the diet comprise less than 1 mm in size.

21. The method of any one of claims 15-20, wherein the stabilized pH after addition of 0.3 mol/kg HCl to a 10% suspension of the animal feed is less than 4.2.

22. The method of any one of claims 15-20, wherein less than 0.44 mol/kg HCl is added to a 10% suspension of the animal feed to reach a pH-value of 4.0.

23. The method of any one of claims 15-22, wherein the diet further comprises one or more additional enzymes selected from the group consisting of a xylanase, amylase, phytase, glucoamylase, pectinase, mannanase, and β-glucanase.

24. The method of any one of claims 15-23, wherein the diet further comprises one or more direct fed microbials (DFMs) or fermentates thereof.

25. The method of claim 24, wherein the DFM comprises a bacterium from one or more of the following genera: Lactobacillus, Lactococcus, Streptococcus, Bacillus, Pediococcus, Enterococcus, Leuconostoc, Carnobacterium, Propionibacterium, Bifidobacterium, Clostridium or Megasphaera and combinations thereof.

26. The method of claim 24 or claim 25, wherein the DFM comprises a bacterium from one or more of the following species: Bacillus subtilis, Bacillus licheniformis, Bacillus amyloliquefaciens, Enterococcus sp, Pediococcus sp, Lactobacillus sp, Bifidobacterium sp, Lactobacillus acidophilus, Pediococsus acidilactici, Lactococcus lactis, Bifidobacterium bifidum, Propionibacterium thoenii, Lactobacillus farciminus, Lactobacillus rhamnosus, Clostridium butyricum, Bifidobacterium animalis ssp. animalis, Lactobacillus reuteri, Bacillus cereus, Lactobacillus salivariu, Megasphaera elsdenii, Propionibacteria sp, or combinations thereof.

27. The method of any one of claims 15-26, wherein the diet further comprises one or more essential oils.

28. The method of claim 27, wherein the essential oil is thymol and/or cinnamaldehyde.

29. The method of any one of claims 15-28, wherein the animal is a monogastric animal.

30. The method of claim 29, wherein the animal is poultry (for example, broilers, layer, broiler breeders, turkey, duck, geese, pheasant, columbidae or water fowl), swine, rabbits, calves, cows, goat, sheep, insects, a companion animal (for example dogs, cats) or fish.

31. A diet formulated by the method of any one of claims 15-30.

32. A diet comprising:
(a) a feed additive composition comprising a protease;
and (b) one or more of
(i) a soybean meal having an acid detergent fiber (ADF) content greater than about 56 g/kg; and/or
(ii) a soybean meal having a sulfur-containing amino acid content of less than about 13 g/kg;
wherein, optionally,
(iii) a majority of particles in the diet comprise less than 1 mm in size; and/or
(iv) the diet has low buffer capacity.

33. The diet of claim 32, wherein the protease is a subtilisin, a bacillolysin, an alkaline serine protease, a keratinase or a Nocardiopsis protease.

34. The diet of claim 33, wherein the protease is 80% identical to the protease of SEQ ID NO:1.

35. The diet of any one of claims 32-34, wherein the ADF content of the soybean meal is greater than about 58 g/kg, 60 g/kg, 62 g/kg, 64 g/kg, or 66 g/kg.

36. The diet of any one of claims 32-35, wherein the sulfur-containing amino acid content of the soybean meal is less than about 12 g/kg or 11 g/kg.

37. The diet of any one of claims 32-36, wherein at least about 60% of the particles in the diet comprise less than 1 mm in size.

38. The diet of any one of claims 32-37, wherein the stabilized pH after addition of 0.3 mol/kg HCl to a 10% suspension of the animal feed is less than 4.2.

39. The diet of any one of claims 32-37, wherein less than 0.44 mol/kg HCl is added to a 10% suspension of the animal feed to reach a pH-value of 4.0.

40. The diet of any one of claims 32-39, wherein the feed additive composition further comprises one or more additional enzymes selected from the group consisting of a xylanase, amylase, phytase, glucoamylase, pectinase, mannanase, and β-glucanase.

41. The diet of any one of claims 32-40, wherein the feed additive composition further comprises one or more direct fed microbials (DFMs) or fermentates thereof.

42. The diet of claim 41, wherein the DFM comprises a bacterium from one or more of the following genera: Lactobacillus, Lactococcus, Streptococcus, Bacillus, Pediococcus, Enterococcus, Leuconostoc, Carnobacterium, Propionibacterium, Bifidobacterium, Clostridium or Megasphaera and combinations thereof.

43. The diet of claim 41 or claim 42, wherein the DFM comprises a bacterium from one or more of the following species: Bacillus subtilis, Bacillus licheniformis, Bacillus amyloliquefaciens, Enterococcus sp, Pediococcus sp, Lactobacillus sp, Bifidobacterium sp, Lactobacillus acidophilus, Pediococsus acidilactici, Lactococcus lactis, Bifidobacterium bifidum, Propionibacterium thoenii, Lactobacillus farciminus, Lactobacillus rhamnosus, Clostridium butyricum, Bifidobacterium animalis ssp. animalis, Lactobacillus reuteri, Bacillus cereus, Lactobacillus salivariu, Megasphaera elsdenii, Propionibacteria sp, or combinations thereof.

44. The diet of any one of claims 32-43, wherein the feed additive composition further comprises one or more essential oils.

45. The diet of claim 44, wherein the essential oil is thymol and/or cinnamaldehyde.

46. A method for improving feed conversion ratio (FCR) or for increasing body weight gain in an animal comprising administering the diet of any one of claims 32-45 to the animal.

47. The method of claim 46, wherein the animal is a monogastric animal.

48. The method of claim 47, wherein the animal is poultry (for example, broilers, layer, broiler breeders, turkey, duck, geese, pheasant, columbidae or water fowl), swine, rabbits, calves, cows, goat, sheep, horses, insects, a companion animal (for example dogs, cats) or fish.
